(19) United States
(12) Patent Application Publication
(10) Pub. No.: US 2023/0131458 A1
(43) Pub. Date: Apr. 27, 2023

(54) PROBE SENSOR

(71) Applicant: Duality Robotics, Inc., San Mateo, CA (US)

(72) Inventors: Massimo Isonni, Desenzano del Garda (IT); Apurva Shah, San Mateo, CA (US); Roberto De Ioris, Rome (IT); Francesco Leacche, Rome (IT); Michael Taylor, Wedcord, PA (US)

(21) Appl. No.: 17/969,895

(22) Filed: Oct. 20, 2022

Related U.S. Application Data
(60) Provisional application No. 63/262,821, filed on Oct. 21, 2021.

(51) Int. Cl. B25J 9/16; B25J 13/00

(52) U.S. Cl. CPC B25J 9/1605; B25J 9/1697; B25J 13/006; B25J 9/1653

(57) ABSTRACT

Techniques are described to implement a probe sensor that improves data capture and data analysis. A probe sensor can be emulated in a virtual environment. A robot simulation session is initialized. The session includes a virtual environment with several objects and a set of robots. Each robot has a virtual sensor. A separate client controls each robot. Data perceived by the virtual sensor is provided to the client for controlling the robot. To capture the data the virtual sensor emits a plurality of rays, each ray transmitted in a stochastically selected direction, and performs raytracing to determine an object(s) in the virtual environment on which each ray is incident. The stochastic data capture can also be performed by a sensor in a real world scenario. Further, in some cases, the data captured by a sensor is stochastically sampled to improve the computing.

### CROSS-REFERENCE TO RELATED APPLICATIONS

This application claims the benefit of and priority to U.S. Provisional Application No. 63/262,821 filed Oct. 21, 2021, entitled “Stochastic Approach to Modeling Perception Sensors,” the contents of which are incorporated by reference herein in their entirety.

### BACKGROUND

The present disclosure relates to computer technology, particularly to instrumentation and more particularly to perception sensors. The present disclosure also relates to aspects of computer technology particularly associated with robotics, and more specifically to a simulation of robot structure and behavior within a virtual environment.

The design and testing of robots can be expensive. In particular, physical buildouts of robots involve multiple robot components that are often costly, such as processors, sensors, effectors, power sources and power buses, and the like. Likewise, robot design and testing can be very time-consuming, often requiring multiple iterations of robot buildouts before a final design is selected. The design, build-out, and test cycle can be iterated multiple times, further increasing the costs of robot design. Accordingly, there is a need to streamline robot design and testing in order to both lower costs and reduce the amount of time required to settle on a final robot design.

Testing robot designs includes perception systems, such as visual sensors, audio sensors, motion sensors, proximity sensors, etc. Such perception systems are also incorporated into several devices. For example, phones, computers, tablets, vehicles, home appliances, security systems, drones, etc., are equipped with one or more such perception systems. Such perception systems may employ a combination of sensors, e.g., a camera sensor and a LiDAR (light imaging detection and ranging) sensor; or a camera sensor and a microphone; or any other combination of sensors to perceive the surroundings of the perception system.

### SUMMARY

According to one or more embodiments, a computer-implemented method for emulating a probe sensor in a virtual environment includes initializing, by a cloud server, a robot simulation session. The initializing includes instantiating the virtual environment within the robot simulation session, a plurality of objects of the virtual environment instantiated using one or more environment parameters, and instantiating a set of robots within the virtual environment, each robot comprising a virtual sensor. The method further includes, for each robot from the set of robots, providing control of the robot to a client, wherein data representative of the virtual environment available to the client comprises data perceived by the virtual sensor corresponding to the robot. Capturing the data perceived by the virtual sensor includes emitting a plurality of rays by the virtual sensor, each ray transmitted in a stochastically selected direction, and capturing the data perceived by each ray by raytracing each ray to determine an object in the virtual environment on which the ray is incident.

In some embodiments, a number of rays emitted as part of the plurality of rays from the virtual sensor is stochastically determined.

In some embodiments, a first virtual sensor of a first robot from the set of robots emits a first number of rays and a second virtual sensor of a second robot from the set of robots emits a second number of rays, the first number and the second number being distinct.

In some embodiments, the virtual sensor selects a first set of directions for a first plurality of rays, and a second set of directions for a second plurality of rays, wherein the first plurality of rays is transmitted to capture a first frame of information and the second plurality of rays is transmitted to capture a second frame of information.

In some embodiments, the first frame of information is captured at time t1, and the second frame of information is captured at time t2, t2>t1.

In some embodiments, the virtual sensor is one from a group of virtual sensors comprising a camera, a LIDAR, a radar, and a microphone.

In some embodiments, the data perceived by the virtual sensor comprises an origin of the ray, a direction of the ray, an identification the object, and an identification of a component of the object on which the ray is incident.

In some embodiments, the method further includes, generating a perception stack output of the virtual environment based on the data perceived by the set of robots.

In some embodiments, each robot from the set of robots captures the data perceived at a discrete periodic interval.

According to one or more embodiments, a system includes a cloud server for simulating robot behavior, the cloud server comprising at least one processor configured to execute instructions stored on a non-transitory computer-readable storage medium. The cloud server instantiates a virtual environment within the robot simulation session, the virtual environment comprising a plurality of objects instantiated using one or more environment parameters, the objects comprising one or more robots. The cloud server further instantiates a probe sensor. The probe sensor emits a plurality of rays, each ray transmitted in a stochastically selected direction, and captures data perceived by each ray by raytracing each ray to determine an object in the virtual environment on which the ray is incident. The cloud server generates a perception stack output of the virtual environment based on the data that is captured by the probe sensor, the perception stack output representing state of the plurality of objects in a predetermined vicinity of the probe sensor.

In some embodiments, the system further includes one or more client devices in communication with the cloud server, the one or more client devices configured to provide control of the one or more robots in the virtual environment based on the perception stack output.

In some embodiments, the one or more client devices comprise a first client device that facilitates operating a first robot manually and a second device that autonomously operates a second robot.

In some embodiments, the probe sensor emits a first plurality of rays at a first timepoint t1, and a second plurality of rays at a second timepoint t2, and wherein a number of rays at the first timepoint is different from the number of rays emitted at the second timepoint.

In some embodiments, the number of rays emitted by the probe sensor at any timepoint is stochastically determined.

In some embodiments, the data perceived by a ray from the probe sensor comprises an origin of the ray, a direction of the ray, an identification the object, and an identification of a component of the object on which the ray is incident.

In some embodiments, the probe sensor is mounted on a robot from the set of robots.

According to one or more embodiments, a system to capture data of an environment includes a sensor, and one or more processing units in communication with the sensor, wherein the one or more processing units stochastically select data from a frame captured by the sensor, and determine a perception stack output based on the stochastically selected data.

In some embodiments, the one or more processing units are further configured to use entire data from the frame for a second function, wherein the second function can be one of creating a digital twin, recognizing objects.

In some embodiments, the sensor is one of a LIDAR, a camera, a radar, and a microphone.

In some embodiments, the one or more processing units are further configured to configure the sensor to capture the frame using stochastically emitted rays, and use the entire frame to generate the perception stack output.

Aspects of technical solutions described herein address technical challenges in computing technology, particularly in fields of robotics and instrumentation. One or more aspects of the technical solutions described herein facilitate improvements to perception systems, and sensors (e.g., probe sensors) used by such perception systems. Aspects herein further improve systems that use the perception systems and/or sensors equipped with the technical solutions described herein.

In addition, aspects of the technical solutions described herein provide improvements to a virtual perception system by emulating a probe sensor in the virtual environment that facilitates providing information to efficiently generate/update a perception stack output in the virtual environment to determine objects around the probe sensor and the object's movements.

Additional advantages and improvements will be evident based on the description herein.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings.

FIG. 1 illustrates a system environment of a robot simulation server, according to one embodiment;

FIG. 2A is a block diagram of a robot simulation server, according to one embodiment;

FIG. 2B is a block diagram of clients according to one or more embodiments;

FIG. 3 illustrates a set of virtual robots instantiated within a virtual environment by a robot simulation server, according to one embodiment;

FIG. 4 is a flow chart illustrating a process of simulating robot behavior in a virtual environment, according to one embodiment;

FIGS. 5a-5c illustrate various robots according to one or more embodiments;

FIG. 6 depicts a probe sensor in operation according to one or more embodiments;

FIG. 7 depicts a flowchart of a method for using a probe sensor to capture perceived data and generate perception stack output related to object identification according to one or more embodiments;

FIG. 8 depicts using a hardware sensor to capture surrounding environment in a stochastic manner according to one or more embodiments;

FIG. 9 depicts a flowchart of a method for capturing data of an environment in an efficient manner using probe sensors according to one or more embodiments; and

FIG. 10 depicts a computing environment in accordance with one or more embodiments.

The diagrams depicted herein are illustrative. There can be many variations to the diagrams, or the operations described therein without departing from the spirit of the invention. For instance, the actions can be performed in a differing order, or actions can be added, deleted, or modified. Also, the term “coupled,” and variations thereof describe having a communications path between two elements and do not imply a direct connection between the elements with no intervening elements/connections between them. All of these variations are considered a part of the specification.

In the accompanying figures and following detailed description of the disclosed embodiments, the various elements illustrated in the figures are provided with two or three-digit reference numbers. With minor exceptions, the leftmost digit(s) of each reference number corresponds to the figure in which its element is first illustrated.

### DETAILED DESCRIPTION

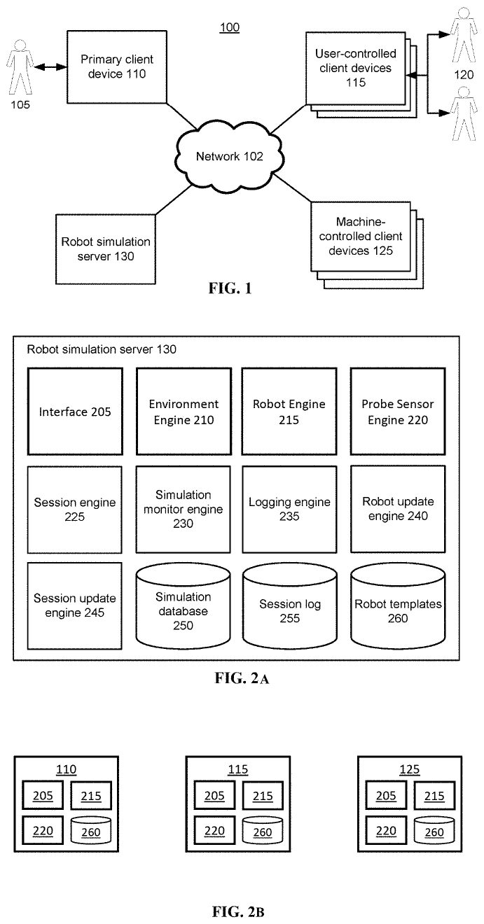

FIG. 1 illustrates a system environment 100 of a robot simulation server 130, according to one embodiment. The system environment 100 (or simply “environment 100”) includes a user 105 associated with a primary client device 110, users 120 associated with a set of user-controlled client devices 115, a set of machine-controlled client devices 125, and a robot simulation server 130, all connected via the network 102. In alternative configurations, different and/or additional components may be included in the system environment 100.

A user 105 of the system environment 100 is an individual that wants to simulate robot structure or behavior using the robot simulation server 130, or that wants to develop data for the training or development of robotic or automated systems. The user 105 interacts with the robot simulation server 130 using the primary client device 110 in order to initialize, customize, begin, run, and monitor a robot simulation session. Likewise, users 120 are individuals that participate in the simulation of robot structure or behavior by controlling one or more virtual robots within a virtual environment generated or instantiated by the robot simulation server 130. The users 120 interact with the robot simulation server 130 using the user-controlled client devices 115, for instance by providing inputs to control the robot via the user-controlled client devices 115. It should be noted that in some robot simulation sessions, the user 105 also controls one or more virtual robots within the virtual environment using the primary client device 110.

The primary client device 110 and each user-controlled client device 115 (collectively and individually referred to as “client device” or “client devices” hereinafter) are one or more computing devices capable of receiving user input as well as transmitting and/or receiving data via a network 102. In one embodiment, a client device is a conventional computer system, such as a desktop or a laptop computer. Alternatively, a client device may be a device having computer functionality, such as a personal digital assistant (PDA), a mobile telephone, a smartphone, or another suitable device. A client device is configured to communicate via a network 102. In one embodiment, a client device executes an application allowing a user of the client device to interact with the robot simulation server 130. For example, a client device executes a browser application or native application to enable interaction between the client device and the robot simulation server 130 via a network 102. In another embodiment, a client device interacts with the robot simulation server 130 through an application programming interface (API) running on a native operating system of the client device, such as IOS® or ANDROID™.

The machine-controlled client devices 125 are client devices that autonomously control virtual robots, virtual people, virtual objects, or portions of the virtual environment during a robot simulation session. As with the user-controlled client devices 115, inputs for controlling one or more virtual robots within a virtual environment generated or instantiated by the robot simulation server 130 are provided by the machine-controlled client device 125. However, unlike the user-controlled client device 115, which provide instructions for controlling virtual robots or manipulating the virtual environment based on inputs received by the users 120, inputs for controlling one or more virtual robots provided by a machine-controlled client device 125 are generated by an autonomous robot control program running on the machine-controlled client device. As used herein, “autonomous robot control program” refers to software or logic implemented or executed by a machine-controlled client device 125 that receives data from one or more virtual sensors of a virtual robot representative of a context, state, and other characteristics of the virtual robot within the virtual environment and provides movement or behavior instructions for the virtual robot based on the received data.

In some embodiments, the machine-controlled client devices 125 are client devices that autonomously control real-world (non-virtual) robots, objects, during a real-world robot simulation session. The primary client device 110 and the user-controlled client devices 115 may also control real-world robots and/or objects in such scenarios. However, unlike the primary client device 110 and the user-controlled client device 115, which provide instructions for controlling robots based on inputs received by the users 120, inputs for controlling one or more robots provided by the machine-controlled client device 125 are generated by the autonomous robot control program running on the machine-controlled client device. In such a real-world scenario, the autonomous robot control program is executed by the machine-controlled client device 125 that receives data from one or more physical/real-world (non-virtual) sensors of a robot representative of a context, state, and other characteristics of the robot within the real-world environment and provides movement or behavior instructions for the robot based on the received data.

It should be noted that in various embodiments, the primary client device 110, the user-controlled client devices 115, and the machine-controlled client devices 125 overlap. For instance, the primary client device 110 can be used by the user 105 to request a robot simulation session, but can include an autonomous robot control program configured to control a robot during the simulation session autonomously. It should also be noted that in some embodiments, the primary client device 110, the user-controlled client devices 115, and/or the machine-controlled client devices 125 can, collectively or individually, be implemented within a network of one or more computers that collectively interact with the robot simulation server 130.

In some embodiments, a user (such as the user 105 or the users 120) can monitor the autonomous operation of a robot during the robot simulation session by an autonomous robot control program, but can assume manual control of the robot (or “intervene” as used herein) during the simulation session. The robot can be operated in a real-world simulation or a virtual simulation. In some embodiments, a user (such as the user 105 or the users 120) can monitor the autonomous control of a robot, individual, or object within a virtual environment by the robot simulation server 130 (as opposed to by a machine-controlled client device 125), and can manually assume control of the monitored robot, individual, or object, for instance using the primary client device 110 or a user-controlled client device 115.

The robot simulation server 130 is a server that enables the simulation of robot structure and behavior within a virtual environment. The robot simulation server 130 is any computing system configured to perform the functions described herein. In some embodiments, the robot simulation server 130 is a standalone server or is implemented within a single system, such as a cloud server, while in other embodiments, the robot simulation server is implemented within one or more computing systems, servers, data centers, and the like. The functionality and components of the robot simulation server 130 is described below in greater detail.

The primary client device 110, the user-controlled client devices 115, the machine-controlled client devices 125, and the robot simulation server 130 communicate via the network 102, which may include any combination of local area and/or wide area networks, using both wired and/or wireless communication systems. In one embodiment, the network 102 uses standard communications technologies and/or protocols. For example, the network 102 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 102 include multiprotocol label switching (MPLS), transmission control protocol/Internet protocol (TCP/IP), hypertext transport protocol (HTTP), simple mail transfer protocol (SMTP), file transfer protocol (FTP), and User Datagram Protocol (UDP). Data exchanged over the network 102 may be represented using any suitable format, such as hypertext markup language (HTML) or extensible markup language (XML). In some embodiments, all, or some of the communication links of the network 102 may be encrypted using any suitable techniques.

As used herein, “robot” can refer to a robot in a traditional sense (e.g., a mobile or stationary robotic entity configured to perform one or more functions), and can also refer to any system or vehicle that can be autonomously and/or remotely controlled, or that executes autonomous control logic. Further, a “robot” can also be a virtual robot. For instance, the robot simulation server 130 can instantiate robots, automobiles (such as autonomously or manually controlled cars and trucks), construction equipment (such as autonomously or manually controlled bulldozers, excavators, and other tractors), delivery robots and vehicles, manufacturing robots and articulated arms, warehouse robots, logistics robots, drones and other aerial systems and vehicles, boats, motorcycles, scooters, spaceships and space robots, security systems, intrusion detection systems, monitoring systems, smart home or building systems, smart city or city planning systems, or any suitable system that can be autonomously and/or manually controlled.

By enabling a user (such as the user 105) to simulate the structure and behavior of a robot, the robot simulation server 130 can enable the user to test the design of a robot without having to physically assemble the robot and to create real-world environments and scenarios in which to test the robot. Such simulation can thus potentially save the user significant money that might otherwise be required to purchase and use robot components and in early or non-final iterations of the robot design. Likewise, by enabling the user to toggle, update, or modify aspects of the robot's design (for instance, by changing one or more characteristics of the robot) within the simulation, the amount of time that might otherwise be required to physically re-assemble an updated robot design is reduced or eliminated. Finally, the robot simulation server 130 can enable a user to test the logic, artificial intelligence, or autonomous robot control program used to control a real-world robot but within a virtual environment, beneficially increasing the safety of such testing and reducing the amount of time that might otherwise be required to update the control program and upload/install it to a real-world robot, further reducing the time, cost, and resources otherwise required to physically test the logic used to control the robot and to gather data required for training machine learning models and AI for use in controlling the robot.

After the user simulates the design of the structure and behavior of one or more robots within a virtual environment, the user can select an optimal design from the simulated designs. For instance, the user may select a design that performed best under certain circumstances, which performed best overall, that is the least expensive to produce while still satisfying one or more criteria, or based on any other suitable factors. The user can then build a robot in the real-world based on the selected design. Likewise, the user can use information gathered during the simulation of various robot designs to refine an existing robot design.

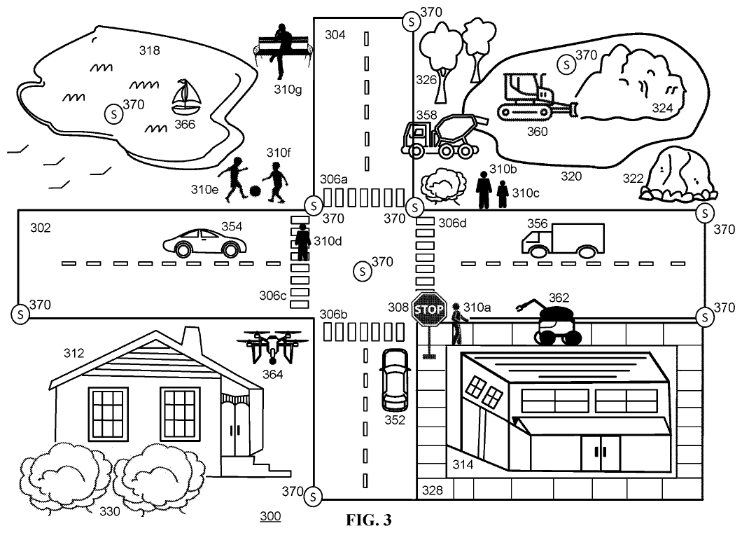

FIG. 2A is a block diagram of a robot simulation server 130, according to one embodiment. In the embodiment of FIG. 2A, the robot simulation 130 includes an interface module 205, an environment engine 210, a robot engine 215, a probe sensor engine 220, a session engine 225, a simulation monitor engine 230, a logging engine 235, a robot update engine 240, a session update engine 245, a simulation database 250, a session log 255, and a robot templates storage module 260. In alternative configurations, different and/or additional components may be included in the robot simulation server 130.

FIG. 2B is a block diagram of clients 110, 115, 125 according to one or more embodiments. In some embodiments, each client 110, 115, 125 includes an interface 205, a robot engine 215, a probe sensor engine 220, and robot templates 260. In some embodiments, the components of the clients 110, 115, 125 may be used to perform one or more operations (described herein) instead of those in the robot simulation server 130. In other embodiments, the components in the clients 110, 115, 125 operate in cooperation with (using distributed computing principles) the components of the robot simulation server 130. In some embodiments, the clients 110, 115, 125 may share/replace fewer, additional, or different components with/from the robot simulation server 130 than those depicted in FIG. 2B. Further, in alternative configurations, different and/or additional components may be included in the clients 110, 115, 125.

The interface module 205 provides a communicative interface between entities within the environment 100, between users 105 and 120 (via the primary client device 110 and the user-controlled client devices 115, respectively) and the robot simulation server 130, between multiple components of the simulation server 130, and between components of the simulation server and entities within the environment 100. The interface module 205 enables communications within the environment 100 by implementing any data transfer protocols necessary for communications between the various entities and components of the environment.

The interface module 205 can also provide a user interface that allows users (such as the user 105 and users 120) to interact with the robot simulation server 130. Through various elements of the user interface, such as graphical user interfaces displayed by a client device (such as the primary client device 110 and the user-controlled client devices 115), a user can initialize, customize, begin, run, and monitor a robot simulation session. Likewise, through the user interface, the users 105 and 120 can control one or more virtual robots, can view and interact with a virtual environment (e.g., by manipulating, in real-time during a simulation, a portion of the virtual environment, an object within the environment, etc. to test, for instance, how a robot's autonomous control logic will handle a human jumping in front of the robot during the simulation session), can monitor the autonomous control of one or more virtual robots and can intervene to assume manual control of the virtual robots, can monitor data associated with a structure or behavior of one or more virtual robots, and can re-customize one or more virtual robots and/or re-run a portion of the robot simulation.

The environment engine 210 instantiates and generates a virtual environment in which robot structure and behavior can be simulated. As used herein, “virtual environment” refers to a computer-rendered representation of reality. The virtual environment includes computer graphics representing objects and materials within the virtual environment, and includes a set of property and interaction rules that govern characteristics of the objects within the virtual environment and interactions between the objects. In some embodiments, the virtual environment is a realistic (e.g., photo-realistic, spatial-realistic, sensor-realistic, etc.) representation of a real-world location, enabling a user (such as the user 105) to simulate the structure and behavior of a robot in a context that approximates reality.

The properties, characteristics, appearance, and logic representative of and governing objects (such as people, animals, inanimate objects, buildings, vehicles, and the like) and materials (such as surfaces, ground materials, and the like) for use in generating a virtual environment can be stored in the simulation database 250. Accordingly, when the environment engine 210 generates a virtual environment, an object selected for inclusion in the virtual environment (such as a park bench, or a sandy beach) can be accessed from the simulation database 250 and included within the virtual environment, and all the properties, characteristics, appearance, and logic for the selected object can succinctly be instantiated in conjunction with the selected object. In some embodiments, a user (such as the user 105) can manually generate an object for inclusion in the virtual environment (for instance, by uploading a CAD file representative of a structure of the object, by customizing various properties of the object, and the like), and the manually generated object can be stored by the environment engine 210 in the simulation database 250 for subsequent use in generating virtual environments.

The environment engine 210 can include a graphics or rendering engine (“graphics engine” hereinafter) configured to generate the virtual environment. In some embodiments, the rendering of the environment (and other clients) is specific to the point-of-view of each robot that is being controlled by one of the clients 110, 115, 125. Accordingly, each client 110, 115, 125 also includes the rendering engine or at least parts of the rendering engine. The environment engine 210 that runs on the server 130 is shared between all the clients 110, 115, 125 for parts of the environment that is common to all the clients, in some embodiments. Each individual client 110, 115, 125 implements a respective robot in the virtual environment and sends updates to the robot simulation server 130 to synchronize the robot state with other clients. Each client 110, 115, 125, can be responsible for rendering a view of the virtual environment based on the corresponding robot's point of view and updates received from the robot simulation server 130. The graphics engine can, using one or more graphics processing units, generate three-dimensional graphics depicting the virtual environment, using techniques including three-dimensional structure generation, surface rendering, shading, ray tracing, ray casting, texture mapping, bump mapping, lighting, rasterization, and the like. In some embodiments, the graphics engine includes one or more rendering APIs, including but not limited to Direct3D, OpenGL, Vulkan, DirectX, and the like. The rendering engine can, using one or more processing units, generate representations of other aspects of the virtual environment, such as radio waves within the virtual environment, GPS signals within the virtual environment, and any other aspect of the virtual environment capable of detection by a virtual sensor.

The environment engine 210 can also include a physics engine configured to generate and implement a set of property and interaction rules within the virtual environment. In practice, the physics engine implements a set of property and interaction rules that mimic reality. The set of property rules can describe one or more physical characteristics of objects within the virtual environment, such as characteristics of materials the objects are made of (like weight, mass, rigidity, malleability, flexibility, temperature, and the like). Likewise, the set of interaction rules can describe how one or more objects (or one or more components of an object) interact (for instance, describing a relative motion of a first object to a second object, a coupling between objects or components, friction between surfaces of objects, and the like). The physics engine can simulate rigid body dynamics, collision detection, soft body dynamics, fluid dynamics, particle dynamics, and the like. Examples of physics engines include but are not limited to the Open Dynamics engine, Bullet, PhysX, the Havok engine, and the like.

In some embodiments, the environment engine 210 utilizes existing game engines (which include graphics and physics engines) in order to generate a virtual environment. In some embodiments, the environment engine 210 generates the virtual environment using one or more of: the Unreal Engine, Unity, GameMaker, Godot, AppGameKit, and CryEngine. In addition, the environment engine 210 can include sound engines to produce audio representative of the virtual environment (such as audio representative of objects within the virtual environment, representative of interactions between objects within the virtual environment, and representative of ambient or background noise within the virtual environment). Likewise, the environment can include one or more logic engines that implement rules governing a behavior of objects within the virtual environment (such as a behavior of people, animals, vehicles, or other objects generated within the virtual environment that are controlled by the robot simulation server 130 and that are not controlled by users such as user 105 and users 120).

The virtual environment generated by the environment engine 210 can include one or more ground surfaces, materials, or substances (such as dirt, concrete, asphalt, grass, sand, water, and the like). The ground surfaces can include roads, paths, sidewalks, beaches, and the like. The virtual environment can also include buildings, houses, stores, restaurants, and other structures. In addition, the virtual environment can include plant life, such as trees, shrubs, vines, flowers, and the like. The virtual environment can include various objects, such as benches, stop signs, crosswalks, rocks, and any other object found in every-day life. The virtual environment can include representations of particular location types, such as city blocks in dense urban sprawls, residential neighborhoods in suburban locations, farmland and forest in rural areas, construction sites, lakes and rivers, bridges, tunnels, playgrounds, parks, and the like. In practice, the virtual environment generated by the environment engine 210 can include a representation of any area within which a user (such as the user 105) wants to simulate the structure and behavior of a robot. It should be noted that in addition to identifying types of objects within the virtual environment, a user 105 may specify a location within the virtual environment at which the various objects within the virtual environment are located. In addition, the virtual environment can include representations of various weather conditions, temperature conditions, atmospheric conditions, and the like, each of which can, in an approximation of reality, affect the movement and behavior of robots during a robot simulation session.

The environment engine 210 generates a virtual environment in response to a request to simulate robot structure and behavior (for instance, in response to a request from the user 105 to begin a robot simulation session). In some embodiments, the environment engine 210 generates a default virtual environment in response to a request to simulate robot structure and behavior. In other embodiments, the environment engine 210 can suggest a virtual environment including a particular location type (e.g., city block, forest, etc.), for instance based on a type of robot to be simulated, based on similar virtual environments generated for the user 105, based on similar virtual environments generated for users similar or related to the user 105, and the like. Likewise, the environment engine 210 can suggest various types of objects for rendering within the virtual environment, based on a property of a robot being simulated, the user 105, users similar or related to the user 105, and the like. The user 105 can select various characteristics of the virtual environment suggested by the environment engine 210, or can manually customize the virtual environment, and the environment engine can, in response, generate the virtual environment according to the characteristics and/or customizations selected by the user. In some embodiments, the environment engine 210 can generate a virtual environment based on rules and distribution parameters set by the user at a prior time. These rules may examine previous simulations (via previous simulation logs) or a scenario library (describing various pre-defined virtual environments) for instance in response to identifying deficiencies in testing a particular virtual environment, condition, or scenario, and can generate a virtual environment to address the identified deficiencies.

The robot engine 215 instantiates and generates one or more robots within the virtual environment generated by the environment engine 210. Each robot generated by the robot engine 215 comprises a robot being simulated within a robot simulation session for control by clients running on one or more of the primary client device 110, the user-controlled client devices 115, and the machine-controlled client devices 125. The robot engine 215 generates a robot by rendering computer graphics representing the robot within the virtual environment, and implementing a set of property and interaction rules that govern characteristics of the robot and interactions between the robot and other robots or objects, structures, and surfaces within the virtual environment. It should be noted that the robot engine 215 can also generate robots that are controlled by the robot simulation server 130.

The properties, characteristics, appearance, and logic representative of and governing robots and robot components can be stored in the simulation database 250. Accordingly, when the robot engine 215 generates a virtual robot, one or more robot components can be selected from the simulation database 250, and all the properties, characteristics, appearance, and logic for the selected robot components can succinctly be included in the instantiating of the robot. In some embodiments, a user (such as the user 105) can manually generate a robot component (for instance, by uploading a CAD file representative of a structure of the robot component, by specifying various materials of the robot component, by specifying the dimensions and shape of the component, and the like), and the manually generated robot component can be stored by the robot engine 215 in the simulation database 250 for subsequent use in generating virtual robots.

The robot engine 215 can generate robots using graphics engines, physics engines, and/or game engines, including any of the engines described above. Each generated robot includes a set of robot components that are coupled together to form the structure of the robot (such as frame components, base components, arm components, cab components, and the like). Likewise, each generated robot can include one or more components configured to interact with other components of the robot (such as two components that are configured to rotate relative to one another, a tread component configured to rotate around a wheelbase component, and the like). Each generated robot can include one or more end-effector components configured to perform one or more functions with regards to the virtual environment (such as a scoop component configured to scoop dirt and sand, a drill component configured to break up materials within the virtual environment, a gripper or claw component, and the like) (collectively, “effector components” or “effectors” hereinafter).

Each generated robot can include one or more components configured to enable the robot to perform a function or operation (such as an engine component, wheels, propellers, and the like). Each generated robot can include a set of virtual sensors, configured to capture data representative of a state, condition, or property of the robot, of other robots, of objects within the virtual environment, or of the virtual environment itself (such as cameras, a LIDAR, a radar, an ultrasonic sensor, a capacitive sensor, a depth sensor, a motion detector, a temperature sensor, a pressure sensor, a microphone, speakers, and the like).

In some embodiments, the robot engine 215 generates one or more robots requested by the user 105. For instance, the user 105 may request two autonomous automobile robots, one manually controlled automobile robot, two delivery truck robots, four drone robots, and one excavator robot, and the robot engine 215, in response to the request, generates each of the requested robots. Alternatively, the user 105 may request an autonomous automobile robot and a virtual environment representative of a city block, and the robot engine 215 may generate the requested autonomous automobile robot and a set of additional robots, which are representative of vehicles that might be expected in a real city block. In some embodiments, the robots are instantiated at locations within the virtual environment specified by the user 105, while in other embodiments, the locations of the instantiated robots within the virtual environment are selected by the robot engine 215.

The user 105 may request a robot by specifying particular components and functions of the robot. For instance, the user 105 may request an automobile of a particular dimension, with exterior panels made of a particular material, and that is battery-powered. Likewise, the user 105 may request an excavator with a particular arm length, a particular lift capacity, and a particular horsepower. In response to a user request, the robot engine 215 can generate virtual robots customized according to the request. In some embodiments, the robot engine 215 can suggest a set of robot templates to the user 105, for instance each specifying one or more of: a robot base type, a robot body type, one or more robot attachments, one or more robot effectors, and one or more sensors. In response, the user 105 can select a displayed template and can customize the robot corresponding to the selected template according to the user's needs (for instance, specifying a mass of various components, an amount of power available to the robot, and the like). Alternatively, the user 105 can generate a new robot template, or the robot engine 215 can generate a robot template from a robot manually created and customized by the user. Robot templates can be stored within the robot templates storage module 260 for subsequent access by the robot engine 215.

It should be noted that the user 105 can customize other portions of the robot simulation session as well. For instance, the user 105 can select a top speed for each robot within the virtual environment, can select an initial position and orientation for each robot or object within the virtual environment, can select an initial speed for each robot within the virtual environment, can select a mission or goal of an autonomously controlled robot within the virtual environment, and the like. Likewise, the user 105 may select a virtual fuel amount available to each robot within the virtual environment, representing an amount of fuel that might be available to a real-world counterpart to each virtual robot. The user 105 may select a number of traffic lights within the virtual environment, a size and scope of the virtual environment, a color and shape of objects within the virtual environment, an orientation or behavior of object within the virtual environment, a number of people within the virtual environment, environmental conditions within the virtual environment, a level of noise within the environment (e.g., audible noise, sensor signal noise), and the like. The user 105 may select various scenarios within the virtual environment, for instance a footrace down a road within the virtual environment, a fire within a building of the virtual environment, a rescue operation within the virtual environment, a pedestrian crossing a street within the virtual environment, a pedestrian stepping in front of a moving vehicle within the virtual environment, and the like. The environment engine 210 and the robot engine 215, in response to customization selections or requests to the virtual environment or the virtual robots within the virtual environment, can modify the virtual environment or the virtual robots to reflect these customizations.

In some embodiments, the creation of a virtual environment and virtual robots within the virtual environment is done by implementing layers. As used herein, “layer” refers to a set of definitions (such as attribute definitions) corresponding to a portion of the virtual environment or one or more robots. Alternatively, in some embodiments, “composition arcs” can be used instead of layers. It is understood that technical solutions described herein are applicable irrespective of specific implementation of the virtual environment. For instance, a ground surface layer/composition arc can be defined by the environment engine 210, a building layer/composition arc defining buildings within the virtual environment can be defined relative to the ground surface, an object layer/composition arc defining objects within or relative to the buildings can be defined relative to the building, and the like. Likewise, a robot base layer/composition arc can be defined by the robot engine 215, a robot body layer/composition arc defining the robot's body can be defined relative to the robot base, one or more robot attachment layers/composition arcs can be defined relative to the robot body, and the like. By rendering portions of the virtual environment and the virtual robots using layers or composition arcs, customizations by the user 105 can be quickly implemented by modifying only the layers/composition arcs corresponding to the customizations, preventing the need to re-generate all layers/composition arcs within the virtual environments or the virtual robots. Likewise, robot behavior can be modified non-destructively by adding partial layer/composition arc definitions, for example, changing sensor position and rotation, without specifying the rest of the robot or sensor behavior. Layers/Composition arcs also allow the customization of a robot by adding an incremental layer/composition arc adjusting one or more characteristics or parameters of the robot on top of the robot definition.

FIG. 3 illustrates a set of virtual robots instantiated within a virtual environment by a robot simulation server 130, according to one embodiment. It should be noted that the illustration is just one example of a virtual environment and virtual robots. In other embodiments, different types of virtual environments with different objects can be generated, and a different set of virtual robots (including more, fewer, or different virtual robots than those illustrated) can be generated within the virtual environment.

In the embodiment depicted, the virtual environment 300 generated by the environment engine 210 is representative of a city block, and includes two different intersecting roads, road 302 and road 304. The roads include various features, such as crosswalks 306a-306d, lane lines (not numbered), and the stop sign 308. Each of roads 302 and 304 bisect the virtual environment, creating four non-road portions of the virtual environment.

The environment engine 210 populates a first non-road portion of the virtual environment with a house 312, populates a second portion with a place of business 314 (such as a grocery store), populates a third portion with a lake 318, and populates a fourth portion with a construction site 320. The environment engine 210 further instantiates various people within the virtual environment 300, such as persons 310a-310g. The environment engine 210 also instantiates other objects within the virtual environment, such as the rock 322, the dirt pile 324, the trees 326, the sidewalk 328, and the shrubs 330. Finally, although not numbered, the environment engine 210 can instantiate various ground types within the virtual environment 300, such as a dirt ground type within the construction site 320, a grass ground type around the house 312, and a sand ground type around the lake 318.

In the embodiment herein, various robots are generated by the robot engine 215 within the virtual environment 300. For instance, the robot engine 215 instantiates various road vehicles, such as the autonomous automobile 352, the user-driven automobile 354, and the delivery truck 356. Likewise, the robot engine 215 instantiates various construction vehicles, such as the autonomous cement mixer 358 and the autonomous bulldozer 360. Finally, the robot engine 215 instantiates other robots, such as the sidewalk delivery robot 362, the drone 364, and the autonomous boat 366. Note that the robot engine 215 can also generate robots, people, and objects within the virtual environment 300 that are not controlled by a client, and are instead controlled directly by the robot simulation server 130.

The locations and types of each of the objects, structures, ground types, people, and robots within the virtual environment 300 can be selected by a user, such as the user 105. In one or more embodiments, these locations and types of objects, robots, and the like can be included within a request to simulate robot structure and behavior, can be selected by the user when initializing a robot simulation session, and can be customized by the user as needed.

Returning to FIG. 2A, the session engine 225 enables the creation and execution of a robot simulation session. In particular, the session engine 225 can receive a request from the user 105 to simulate robot structure and behavior, and can initialize a robot simulation session in response. In some embodiments, the initialization of a robot simulation session includes receiving simulation session parameters from the user 105, such as virtual environment parameters and robot parameters, and the session engine 225 coordinates with the environment engine 210 and the robot engine 215 to instantiate a virtual environment and one or more robots within the virtual environment, respectively, based on the received simulation session parameters.

After the virtual environment and the one or more robots have been generated, the session engine 225 establishes a communicative connection between each of the one or more robots (and people, objects, and other agents to be controlled by a client) and clients running on one or more of the primary client device 110, the user-controlled client devices 115, and the machine-controlled client devices 125. After the robots have been instantiated within the virtual environment, but before control of the robots has been provided to the clients, the robots may be referred to as “pawns.” Each pawn may be stationary within the virtual environment until control of the pawn has been provided to a client.

The session engine 225 selects a client to control each robot during the robot simulation session, enabling data detected by the virtual sensors of each robot to be provided for display or presentation to a user of a corresponding client or an autonomous robot control program (such as camera data, audio data, lidar data, joint angle data, and the like), and enabling inputs provided by the users of the clients (or the autonomous robot control program) to be provided to the session engine 225 in order to control the movement and behavior of the robots. For example, in a robot simulation session that includes three robots, control of a first robot may be provided to a client running on the primary client device 110 for control by the user 105, control of a second robot may be provided to a client running the a user-controlled client device 115 for control by a user 120, and control of a third robot may be provided to a client running on a machine-controlled client device 125 for control by an autonomous robot control program running on the machine-controlled client device.

In some embodiments, the user 105 selects the clients or client devices to which control of the various instantiated robots (or people, objects, and other user-controlled entities within the virtual environment) is to be provided. In some embodiments, the user 105 specifies a type of robot control (e.g., human operation, machine-controlled operation), and the session engine 225 selects clients accordingly. After control of each instantiated robot has been provided to a corresponding client (or after control of a threshold number of robots has been provided), the session engine 225 can begin the simulation session. In some embodiments, the user 105 is prompted to begin the simulation session, while in other embodiments, the simulation session can begin automatically after control of the instantiated robots has been assigned.

After the robot simulation session has begun, the session engine 225 manages the simulation session by moving and simulating behavior for the robots within the virtual environment based on inputs received from the one or more clients to which control of the robots has been assigned. For instance, if a first user instructs a first robot (an automobile) via a client corresponding to the first robot to move forward down a road within the virtual environment, the session engine 225 simulates the movement of the first robot down the road, by moving the first robot forward along the road within the virtual environment. In such an embodiment, the virtual sensors of the first robot (such as cameras positioned to observe a field of view out a windshield of the automobile that a driver of the automobile might see) transmit data representative of a context, state, or surroundings of the first robot (such as a video field of the field of view in front of the automobile as it moves down the road) observed by the virtual sensors to the client controlling the first robot for display (for instance, to a user of the client). It should also be noted that in some embodiments, part or all of the computation performed by the virtual sensors is performed by the client controlling the robot associated with the virtual sensors. This can beneficially reduce the computational load required by the robot simulation server 130. In some embodiments, data captured by the virtual sensors can subsequently be provided to the robot simulation server 130, for instance in order to produce a session log representative of the simulation session.

Likewise, the session engine 225 may receive input from an autonomous robot control program running on a machine-controlled client device 125 controlling a second robot within the virtual environment, such as an autonomous bulldozer. The received input may instruct the second robot to perform an operation, such as clearing away a pile of rubble within the virtual environment. In response, the session engine 225 simulates the movement of the second robot based on the received input, and simulates the movement of rubble as the second robot is simulated to make contact with the pile of rubble. For instance, in accordance with the received input, the bulldozer can be simulated to line up with the pile of rubble, to lower a bulldozer blade close to the ground of the virtual environment, to drive forward into the pile of rubble, and to simulate the movement of the portion of the pile of rubble aligned with the bulldozer blade away from the bulldozer blade as though the bulldozer blade and rubble were real. The received inputs can instruct the bulldozer to move forward by a specified distance in each clearing sweep, can instruct the bulldozer to iterate through the bulldozing process a specified number of times, or can instruct the bulldozer to continue to iterate through the bulldozing process until a specified condition is satisfied (e.g., the pile of rubble is cleared). Likewise, the received inputs can be actuator-specific instructions (e.g., set throttle to 50%, turn front wheels 30 degrees to the right, apply brakes by 20%, set motor speed to 2100 rpm, set tract rotations to 10 rpm, etc.).

The session engine 225 thus simulates movement and behavior of each robot simulated within the virtual environment. In some embodiments, multiple “players” (the clients, users, or autonomous robot control programs) control the robots within a sandbox-type virtual environment during the robot simulation session. The virtual environment (including each structure, surface, material, or object within the virtual environment) is updated in real-time as the robots move and perform various functions within the virtual environment. When a robot makes contact with an object within the virtual environment, the object can move or react to the contact, for instance representative of such contact between a robot and an object in the real-world. Likewise, the session engine 225 can simulate interactions or collisions between robots within the virtual environment. For instance, if a first robot runs into a second robot within the virtual environment, the appearance or functionality of one or both of the first robot and the second robot within the virtual environment can be affected (e.g., structural damage to a robot can be rendered, functionality of a robot can be impaired, and the like). Likewise, the session engine 225 can simulate constructive interactions between robots. For instance, an excavator robot can be instructed to scoop dirt from a virtual construction site and empty the dirt into a hauler robot, which can be instructed to position itself adjacent to the excavator robot when empty, and to drive to a dump site when full. It should be noted that in some embodiments, instead of the session engine 225 simulating robot movements and behavior based on inputs received by the clients, the clients themselves simulate robot movement and behavior, and simulate environmental interactions (such as the movement of rubble described above). In such embodiments, the robot simulation server 130 receives inputs from the clients describing the robot movement and behavior, and the environmental interactions, and synchronizes the robot behavior and movement and environmental interactions between all of the clients.

The session engine 225 can continue the robot simulation session until one or more criteria to end the simulation session are met. In some embodiments, the criteria to end the simulation session are provided by the user 105 when the simulation is requested. In other embodiments, the criteria to end the simulation session are default criteria, are provided by the robot simulation server 130, are based on a type or number of robots within the simulation session, are provided by the users 120, are based on a type of virtual environment, or are provided by any other suitable entity.

In some embodiments, the criteria to end the simulation session include a time-based criteria. For instance, the simulation session can be configured to run for a threshold amount of time (such as 60 seconds, 10 minutes, 30 minutes, or any other suitable interval of time). In some embodiments, the criteria to end the simulation session include safety or collision criteria. For instance, the simulation session can be configured to run until a virtual pedestrian is struck by a robot within the virtual environment, until two robots collide, until a robot collides with an object or structure within the virtual environment, and the like. In some embodiments, the criteria to end the simulation session include immobilization criteria. For instance, the simulation session can be configured to run until a robot becomes disabled, until a robot runs out of virtual fuel, until a robot becomes stuck within a medium of the virtual environment (such as sand or mud), until a robot is overturned or becomes stuck (e.g., within a hole, between buildings within the virtual environment, and the like), or based on any other criteria.

In some embodiments, the criteria to end the simulation session include threshold criteria. For instance, the simulation session can be configured to stop when a threshold distance has been traversed by one or more robots (either individually or collectively) within the virtual environment, when a threshold number of actions has been performed by the robots within the virtual environment (such as a threshold number of traffic stops, a threshold number of parcels delivered, and a threshold number of robot effector operations performed), or when a threshold amount of the virtual environment (for instance, roads within the virtual environment, ground surface within the virtual environment, and the like) has been traversed by the robot. In some embodiments, the criteria to end the simulation session include intervention criteria. For instance, the simulation session can be configured to stop when or a threshold amount of time after a human intervenes and takes control of a robot from an autonomous robot control program. In some embodiments, the criteria to end the simulation session include participation criteria. For instance, the simulation session can be configured to stop when one or more users (such as user 105 and users 120) disconnect from the simulation session. It should be noted that in such embodiments, instead of stopping the robot simulation session, the robot simulation server 130 or a client device (such as client devices 110, 115, or 125) or the robot simulation server 130 can implement an autonomous robot control program to autonomously control the robot corresponding to each disconnected user for the remainder of the simulation session. In some embodiments, the simulation session can run until the user 105 or any other entity instructs the robot simulation server 130 to end the simulation session.

It should be noted that the robot simulation sessions described herein differ from the use of “bots” within a sandbox environment. In particular, “bots” in video game contexts are controlled by the system that instantiates the virtual environment in which the bots are generated. In contrast, the robot simulation sessions described herein may include robots that are autonomously controlled, but the control of these robots is provided by one or more clients (such clients running on the machine-controlled client devices 125) running on systems remote from the system that instantiates the virtual environment (the robot simulation server 130 of the embodiment of FIG. 2A).

The simulation monitor engine 230 is configured to monitor the state of each robot during a robot simulation session. For instance, the simulation monitor engine 230 can monitor the location, orientation, direction, and speed of each robot within the virtual environment for the entirety of the robot simulation session. Likewise, the simulation monitor engine 230 can monitor operations performed by each robot. For instance, the simulation monitor engine 230 can monitor parcel delivery operations, construction operations, driving operations, flight maneuvers, and the like for each robot within the virtual environment. The simulation engine 230 can monitor interactions between each robot in the virtual environment. For instance, the simulation monitor engine 230 can monitor contact between the robots and people, objects, or structures within the virtual environment, or can monitor contact between the robots and one or more mediums within the virtual environment (such as sand, dirt, water, and snow). The simulation engine 230 can also monitor interactions between robots within the virtual environment. The simulation monitor engine 230 can monitor a context of each monitored operation, interaction, and behavior. For instance, the simulation monitor engine 230 can monitor the surroundings of a robot performing an operation within the virtual environment, an orientation and position of objects within a proximity of the robot, and a time interval during which the operation is performed.

The simulation monitor engine 230 can provide monitored data to a user, such as the user 105 or the users 120. For instance, the simulation monitor engine 230 can provide video streams of robots within the virtual environment, measurement data representative of a state of the monitored robots (such as engine temperatures, fuel levels, robot component stress/force, and the like), or data corresponding to a robot's virtual sensors (in embodiments where sensor data is generated by the robot simulation server 130). In some embodiments, the simulation monitor engine 230 provides summary data to a user, such as a number of robots in a particular portion of the virtual environment, a number of interactions between robots, and the like. In some embodiments, the simulation monitor engine 230 provides anomaly data to a user, such as a data representative of collisions between robots, data representative of disabled robots, data representative of contact between a robot and one or more objects within the virtual environment, and the like.

The simulation monitor engine 230 can provide the monitored data to a user (such as the user 105) within an interface, such as a GUI displayed by a client device (such as the primary client device 110). The interface can be configured to allow for viewing one or more video streams, sensor data streams, robot system or component measurement streams, and the like. In some embodiments, a user can toggle between viewing monitored data corresponding to one robot and viewing monitored data corresponding to multiple robots or all robots within the virtual environment. In some embodiments, the interface can include a map interface representative of the virtual environment. The map interface can include a location of each robot within the virtual environment, and can be updated in real-time to reflect the real-time movement of the robots within the virtual environment. The map interface can further include a location of objects within the virtual environment, and can include information detailing a state of each robot or object.

In some embodiments, the interface displaying monitored data can include a set of interface elements (such as icons, buttons, a list of entries, and the like) that enable a user of the interface to quickly switch between interface views. For instance, if a user clicks on a first icon corresponding to a first robot, monitored data corresponding to the first robot can be displayed within the interface, and when the user subsequently clicks on a second icon corresponding to a second robot, monitored data corresponding to the second robot can instead be displayed within the interface, beneficially enabling a user to quickly switch between perspectives while monitoring a robot simulation session.

In some embodiments, the simulation monitor engine 230 can prioritize the display of certain types of data within an interface. For instance, the simulation monitor engine 230 can implement a set of monitoring rules each detailing a condition that, when satisfied by one or more robots and/or one or more objects within the virtual environment, cause information representative of the rule and the robots or objects that satisfied the condition of the rule to be prominently displayed or prioritized within the interface. For example, the simulation monitor engine 230 can implement a first rule such that when a robot exceeds a threshold speed within the virtual environment, the interface is modified to include a warning indicating that the robot has exceeded the threshold speed. Likewise, the simulation monitor engine 230 can implement a second rule such that when a robot makes contact with a person within the virtual environment, the interface is modified to include a warning indicating the contact with the person.

In some embodiments, monitored information is displayed within a feed or listing that is updated in real-time. The feed can display monitored information chronologically, based on a time within the robot simulation session associated with the information. However, the feed can also be modified to prioritize the display of information associated with monitoring rules, enabling such information (such as the exceeding of the speed threshold or the contact with a person within the virtual environment described above) to be displayed at the top of the feed. In some embodiments, prioritized monitored information can be displayed in a different font or color, can be displayed as pop-ups overlaid on the interface, or can be displayed in a dedicated “warning” or “priority information” portion of the interface.

In some embodiments, the simulation monitor engine 230 can, in conjunction with displaying monitored information to a user (such as the user 105), enable the user to perform one or more actions with regards to the simulation. For instance, the simulation monitor engine 230 can enable the user to stop or pause the simulation, can enable the user to re-assign control of one or more robots to a different entity (e.g., a different user 120 or a different machine-controlled client device 125), can enable the user to assume control of a robot within the virtual environment, can enable the user to record monitored information, can enable the user to make changes to the virtual environment, can enable the user to replay or re-simulation one or more portions of the robot simulation session (described below in greater detail), can enable the user to make a change to one or more robots during the robot simulation session (described below in greater detail), and the like.

In some embodiments, each action that the simulation monitor engine 230 enables the user to perform is associated with an interface element displayed within an interface displaying the monitored information. For instance, each action can be associated with a selectable button that, when selected by the user, causes the associated action to be performed. In some embodiments, the simulation monitor engine 230 enables certain actions to be performed when one or more monitoring rules are satisfied. For instance, if a collision between robots is detected, the simulation monitor engine 230 can, in response, enable the user to view a video feed corresponding to the collision, to identify circumstances within the virtual environment that led to the collision, to save data corresponding to the collision, and the like.

The logging engine 235 captures data representative of the robot simulation session and stores the captured data in the session log 255. Examples of captured data include one or more of data representative of movement of robots within the virtual environment, interactions between robots within the virtual environment, and interactions between the robots and the virtual environment. In addition, captured data can be associated and stored in association with a time within the robot simulation session at which the data was captured. In some embodiments, the logging engine 235 can additionally store one or more of monitored data produced by the simulation monitor engine 230, data representation of a state or position of virtual environment objects (including at the beginning of the robot simulation session, in real-time during the robot simulation session, and at the end of the robot simulation session), inputs received from one or more clients (such as clients running on the primary client device 110, the user-controlled client devices 115, and the machine-controlled client devices 125), and actions taken by users (such as the user 105 or the users 120) during the robot simulation session (such as simulation pauses, robot updates, simulation session updates, and the like).

The session log 255 can be reviewed to identify information representative of a robot simulation session, beneficially enabling users that simulate robot structure and behavior to evaluate the performance of the simulated robots during the simulation session. For instance, a user wishing to identify an optimal top speed or amount of battery power available to a robot can review the session log 255 to determine which of a range of top speeds or battery powers produced an optimal result (e.g., avoiding collisions, enabling sufficient user-control, satisfying a performance metric, and the like). Upon reviewing the session log 255, a user can change one or more properties or characteristics of a simulated robot (such as a type of arms included within the robot, a base type for the robot, a size or mass of the robot, one or more operations available to the robot, and the like) based on the simulation session data included within the session log, and can subsequently re-simulate the structure or behavior of the robot within the virtual environment. Likewise, the user can change one or more properties or characteristics of the virtual environment based on the data within the session log 255, and re-simulate robot structure or behavior within the updated virtual environment in a subsequent robot simulation session.

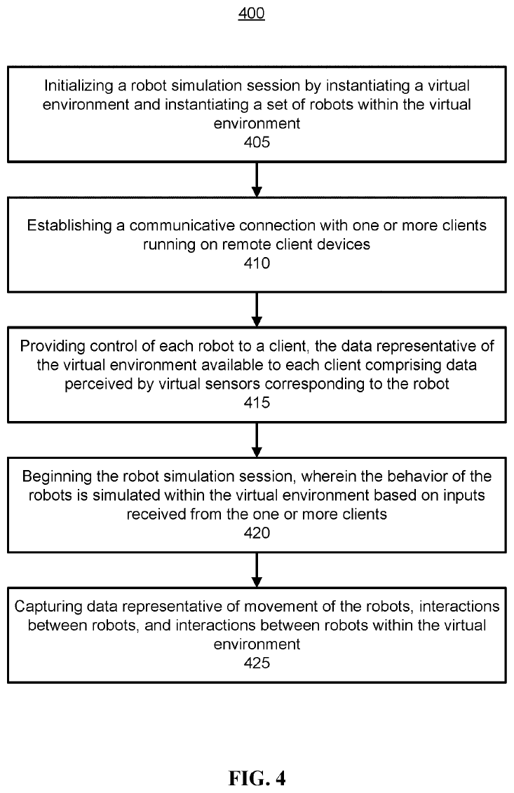

FIG. 4 is a flow chart illustrating a process 400 of simulating robot behavior in a virtual environment, according to one embodiment. A robot simulation session is initialized 405, for instance by a robot simulation server. In some embodiments, initializing a robot simulation session includes instantiating a virtual environment approximating reality, and instantiating a set of robots within the virtual environment. A communication connection is established 410 with one or more clients running on client devices remote from the robot simulation server, such as clients running on user-controlled client devices, and clients controlled by autonomous robot control programs running on machine-controlled client devices.

Control of each robot within the virtual environment is provided 415 to a client. Data representative of the virtual environment available to each client can be limited to data perceived by virtual sensors of the robot controlled by the client (such as video streams from virtual cameras on the robot, sensor data representative of a state of the robot, and the like). The robot simulation session begins 420, and movement and behavior of the robots within the virtual environment is simulated based on inputs from the one or more clients controlling the robots. Data representative of the robots is captured 425 and logged, such as data representative of movement of the robots, interactions between robots, and interactions between robots and the virtual environment.

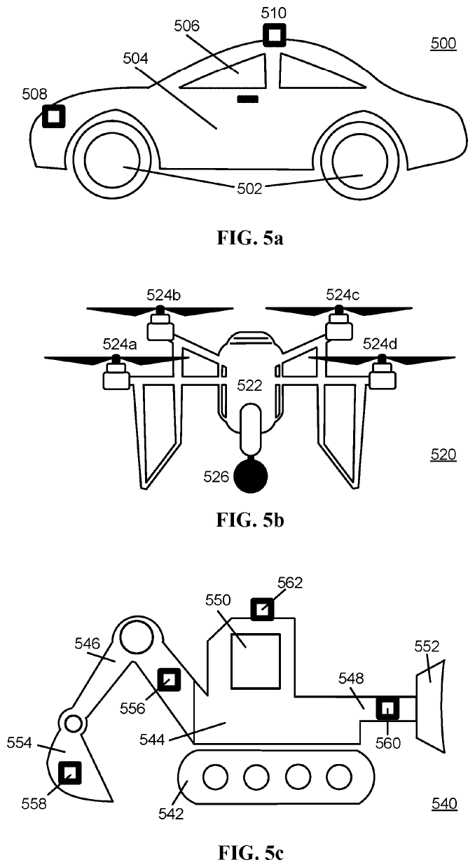

FIGS. 5a-5c illustrate various robots according to one or more embodiments. The robots can be virtual robots created from robot templates as described herein. In particular, FIG. 5a illustrates an example automobile robot 500 created from a robot template, according to one embodiment. In the embodiment of FIG. 5a, the automobile robot 500 is built from a template that specifies a 4-wheel base 502, a sedan body 504, and a sedan cab 506. A user has further customized the instance of the automobile robot 500, for instance by including a LIDAR sensor 508 on the front of the automobile robot and a 360-degree camera sensor 510 on the top of the automobile robot. Further customizations that might not be apparent from the embodiment of FIG. 5a include user-specified dimensions of the automobile robot 500, user-specified automobile robot materials (e.g., an aluminum frame, carbon exterior panels, etc.), user-specified capabilities (e.g., engine type, engine horsepower, available fuel, etc.), and a user-selected color.

FIG. 5b illustrates an example drone robot 520 created from a robot template, according to one embodiment. In the embodiment of FIG. 5b, the drone robot 520 is built from a template that specifies a drone body 522 and four propeller arms 524a, 524b, 524c, and 524d. A user has further customized the drone robot 520, for instance by including a 360-degree camera sensor 526 mounted from the bottom of the drone robot. Further customizations that might not be apparent from the embodiment of FIG. 5b include user-specified weight of the drone robot 520, user-specified arm length, user-specified motor power, user-specified battery capacity, user-specified maximum speed, and altitude, and the like.

FIG. 5c illustrates an example construction robot 540 created from a robot template, according to one embodiment. In the embodiment of FIG. 5c, the construction robot 540 is built from a template that specifies a tread base 542, a tractor body 544, a lifting arm 546, a pushing arm 548, and a tractor cab 550. A user has further customized the construction robot 540, for instance by adding a scoop effector 554 at the end of the first arm 546, by adding a bulldozer blade effector 552 at the end of the second arm 548, by adding a weight sensor 556 within the first arm, by adding a fill capacity sensor 558 within the scoop effector, by adding a force sensor 560 within the second arm, and by adding a LIDAR sensor 562 at the top of the cab 550. Further customizations that might not be apparent from the embodiment of FIG. 5c include user-specified horsepower of an engine of the construction robot 540, a tread type of the tread base 542, a power available to the first arm 546 and the second arm 548, a capacity or dimension of the scoop effector 554, a dimension and material of the bulldozer blade 552, and the like.

Returning to the embodiment of FIG. 2A, the robot update engine 240 enables a user to update one or more aspects of a robot within a simulation. During a simulation, a user (such as the user 105) can determine that the design of a robot being simulated is not ideal, needs to be updated, or is problematic. For instance, a user can determine that the dimensions of a robot are too large for safe operation within a hallway of the virtual environment. Likewise, a user can determine that the amount of battery power allocated to an autonomous electric automobile robot is too low. Finally, a user can determine that the material used within an arm of a construction robot is too weak to lift scooped dirt. In each of these examples, the user may want to change a characteristic of the simulated robot in order to produce a better performing or otherwise more ideal robot design.

Accordingly, the user can provide one or more updated customization parameters to the robot update engine 240. In some embodiments, each provided updated customization parameter changes a characteristic or property of the simulated robot. For instance, an updated customization parameter can change a weight or mass of a robot component, an amount of power available to the robot, or any other robot characteristic or parameter described herein. In some embodiments, the updated customization parameters can include changes to a robot base type, a robot body type, a robot attachment, a robot effector, and a robot sensor, such as any of the bases, bodies, attachments, effectors, and sensors described herein. In some embodiments, the updated customization parameters can include a change to a new robot template stored within the robot templates storage medium 260.

The robot update engine 240 can present interface elements that, when interacted with by a user, assist the user in providing updated customization parameters, for instance within a dedicated robot update interface or within a portion of a simulation session monitoring interface displayed by a client. For instance, the robot update engine 240 can include within an interface displayed by a client each property or characteristic of a robot, each robot component, and each operation available to the robot or a robot component. When a user interacts with, for example, a robot component displayed within the interface, the robot update engine 240 can include one or more interface elements that, when interacted with, enable the user to swap the robot component with a different component, or to modify a property or characteristic of the robot component.

In some embodiments, a user can opt to test a particular robot property or characteristic during a simulation by giving a range of values for the property or characteristic. In response, the robot update engine 240 can increment a value of the property or characteristic based on the range after the passage of an interval of time. For instance, a user may wish to simulate a construction robot with a scoop arm that ranges in length from 6 feet to 10 feet. In this example, the robot update engine 240 can first simulate the construction robot with a scoop arm of 6 feet in length, and can increase the length of the scoop arm by 6 inches every 2 minutes until the scoop arm is 10 feet long. This beneficially enables a user to automatically test out a range of robot configurations without having to manually update the design of the robot multiple times. Likewise, a user can opt to test a range of virtual environment properties or scenarios, for instance by varying a size of an object within the virtual environment, by varying a behavior of a simulated human within the virtual environment, and the like.

Upon receiving the updated customization parameters, the robot update engine 240 can change the design of the simulated robot based on the updated customization parameters within the robot simulation session. In some embodiments, design of the robots being simulated within a robot simulation session can be updated in real-time, during a simulation, allowing an operator of the updated robot to continue to control and operate the robot within the virtual environment during the simulation, and without having to end or re-start the simulation, beneficially reducing the amount of time required to initialize and run a robot simulation session.

Returning to the embodiment of FIG. 2A, the session update engine 245 enables the re-simulation of a portion of a robot simulation session corresponding to the detection of a user intervention of an autonomously controlled robot within a virtual environment. As noted above, a robot can be instantiated within a virtual environment by a robot simulation server 130, and can be autonomously controlled by an autonomous robot control program running on a client remote from a robot simulation server (such as a machine-controlled client device 125). While the robot is being autonomously controlled, a user can monitor the behavior of the robot within the virtual environment, and can intervene to assume control of the robot from the autonomous robot control program. For instance, the user can interact with an interface element displayed by a client autonomously controlling the robot and corresponding to a switch from autonomous robot control to user robot control within the virtual environment. In some embodiments, the user intervention includes a request by the user to pause or stop the robot simulation session, to halt movement or behavior of the robot within the virtual environment, to cause the robot to apply brakes or reduce speed, to cause the robot to alter a direction of movement, to cause the robot to perform an operation that it wasn't otherwise performing, and the like.

When the session update engine 245 detects the user intervention, the session update engine identifies an intervention simulation time corresponding to the user intervention. The session update engine 245 can enable a user (such as the user 105 or, if different, the user that intervened to control the robot) to re-simulate a portion of the robot simulation session corresponding to the detected user intervention. In some embodiments, the session update engine 245 can prompt a user to re-simulate the portion of the robot simulation session corresponding to the detected user intervention at the time of or within a threshold amount of time after detecting the user intervention. In some embodiments, the session update engine 245 can prompt the user to re-simulate the portion of the robot simulation session after the robot simulation session has otherwise concluded.

As described throughout herein, the information of the surrounding virtual environment 300 is captured by the one or more virtual sensors, for example, in the form of video streams from virtual cameras, depth maps and/or point clouds from virtual LIDARs, audio streams from virtual microphones, etc., or a combination thereof. Such data detected by the virtual sensors can be provided for display or presentation to a user of a corresponding client or an autonomous robot control program. The data can enable the users of the clients and/or the autonomous robot control program to provide inputs to the session engine 225 in order to control the movement and behavior of the robots in some embodiments. Alternatively, or in addition, the environment can be updated based on the data that is obtained and observed.

In addition to the virtual sensors that are mounted on the one or more robots (e.g., 362, 364) in the virtual environment 300, in some embodiments, a probe sensor 370 is used to emulate a perception stack to detect the ongoing simulation(s) in the virtual environment 300 by using the returned information (from the probe sensor 370) to determine what objects are around the probe sensor 370 and how the objects are moving. In one or more embodiments, the sensors mounted on the virtual robots can be used as probe sensors 370. Alternatively, separate sensors are designated to operate as the probe sensors 370. The virtual environment 300 can have one or more probe sensors 370 operating simultaneously in some embodiments.

Referring to FIG. 2A, in some embodiments, the robot simulation server 130 includes a probe sensor engine 220 that is responsible for configuring one or more probe sensors 370 and capturing information from the probe sensors 370. In other embodiments, each of the clients 110, 115, 125 includes the probe sensor engine 220. In some embodiments, the probe sensor engine 220 is implemented in a distributed manner across the one or more clients 110, 115, 125, and/or the robot simulation server 130. In some embodiments, the probe sensor engine 220 that is included in a particular client 110, 115, 125 is responsible for configuring and capturing data from one or more probe sensors (370) associated with that particular client. In other embodiments, one or more of the other components of the robot simulation server 130 can be responsible for configuring and capturing information from the probe sensors 370.

Each probe sensor 370 emulates a perception sensor, such as a camera, a LiDAR, a microphone, etc. The probe sensor 370 captures data that informs how a particular device, such as a virtual robot perceives the world, i.e., virtual environment 300, around it. For example, in the scenario of FIG. 3, the probe sensor 370 can be used to detect and identify obstacles in the path of the sidewalk delivery robot 362 to help guide its rerouting so as to enable the most efficient fulfillment. It is understood that the virtual environment 300 and probe sensors 370 are not limited to the specific scenario of FIG. 3, rather can be used to simulate any other scenario/environment, such as a warehouses, factories, parks, or any other such environments.

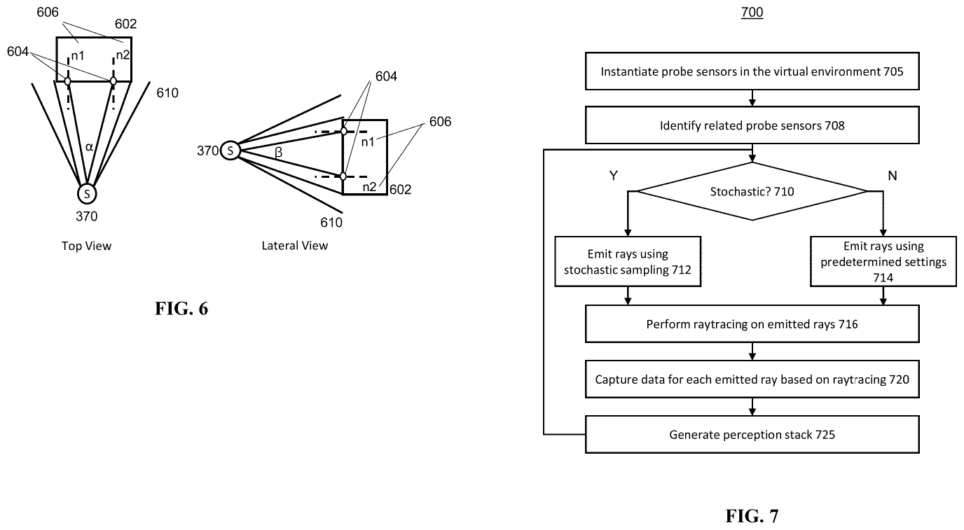

FIG. 6 depicts a probe sensor in operation according to one or more embodiments. The probe sensor 370 gathers data of its surroundings by using ray tracing. Ray tracing is typically used in computer graphics to render a scene and generate digital images. In ray tracing a path from an imaginary eye is traced through each pixel in a virtual screen to calculate a color of an object visible through that ray.

To address the technical challenge of gathering information from its surroundings, the probe sensor 370 transmits/shoots rays 610 in a pyramid based on horizontal and vertical field of view (FOV). The probe sensor 370 transmits rays 610 within predetermined angles α and β in the top and horizontal directions, respectively (to form the pyramid). Typically, several rays 610 are transmitted, each ray 610 being transmitted in a predetermined direction.

The ray 610 that is transmitted is traced by the simulation monitor engine 230 to a point of intersection 604 between the origin (i.e., probe sensor 370) and an object surface 602 in the virtual environment 300. The object 602 can be any one of the several items that are generated by the robot simulation server 130. In some embodiments, the ray 610 is traced only up to a certain distance from the probe sensor 370. For example, the probe sensor 370 may be allocated a particular portion of the virtual environment 300 to monitor and capture information from. Accordingly, the ray 610 is traced only within that allocated region of the probe sensor 370. The allocated region can be specified by providing dimensions of the region in relation with the probe sensor 370 (e.g., radius of a circular region around the probe sensor 370), or providing coordinates of the vertices of the region, or in any other such manner.

In some embodiments, the probe sensor 370 is rendered (i.e., displayed, or shown) in the virtual environment 300. In other embodiments, the probe sensor 370 is not rendered. In some embodiments, users may select whether or not to render the probe sensor 370. Several other settings of the probe sensor 370 can be configured as described herein.

State of the art ray tracing techniques transmit as many number of rays as the number of pixels that are to be rendered. However, unlike the typical ray tracing, where the traced ray is used to determine a color value of pixel that corresponds to the intersecting object 602, the technical solutions described herein address the technical challenge of determining information that can be used for perception of the surroundings.

In some embodiments, each ray 610 returns, based on the point of intersection 602, at least the parameters of RayOrigin, RayCollision, RayDirection, HitObject, HitComponent, HitNormal, HitSegmentationID. It is understood that the names of the parameters can be different from those listed above. Further, in some embodiments, the parameters that are returned by the ray 610 can include fewer, additional, or different parameters. Here, RayOrigin indicates the probe sensor 370 from which the ray 310 was initiated; RayCollision indicates the point of intersection 604; RayDirection is a vector that indicates a direction in the virtual environment 300 in which the ray 210 has been transmitted; HitObject indicates an object of which the point of intersection 604 is part of; HitComponent indicates a portion of the HitObject on which the ray 610 is incident; HitNormal indicates the normal 606 at the point of intersection 604; and HitSegmentationID indicates an identifier of a segment based on segmentation of the data captured by the probe sensor 370. In one or more embodiments, the information parameters listed above can be returned in the form of a single data structure, such as an array, a list, a struct, or any other suitable data structure.

It should be noted that the information can be obtained by tracing the ray 610 across several pixels rendered by the environment engine 210 and identifying a pixel that represents the point of intersection 604. Further, from the identified pixel, the information can be determined, for example, from the environment engine 210 and/or the simulation monitor engine 230. However, using the internal information that is accessible to the robot simulation server 130 in this manner is not possible in a real world scenario. Accordingly, the information is obtained by the probe sensor engine 220 by analyzing the data captured by the probe sensor 370. The analysis can include segmentation, object recognition, etc.

For example, consider a warehouse floor populated with autonomous robots handling fulfillment. Each autonomous robot requires the information obtained by the probe sensor 370 to facilitate efficient and successful fulfillment. It is understood that the warehouse scenario is just one example, and that similar desire to obtain the information from the probe sensor 370 applies to any other scenario, such as a factory, a crosswalk, etc. Tracing rays 610 to obtain the information parameters is computationally expensive. Obtaining the information can be short-circuited using the internal information from the robot simulation server 130 as described herein. Although such short-circuiting can reduce the computational expense to obtain the information, that is not an ideal solution because such short-circuiting is not possible in a real-world scenario.

Technical solutions described herein address such technical challenges regarding the undesirably high computational expense required for the ray tracing. The technical solutions described herein facilitate simulating the probe sensor in a manner in which the rays 610 are distributed for maximum performance and efficiency. Such an improvement is obtained be performing stochastic raytracing, which leverages a random probability ray distribution.

Using the technical solutions described herein, the probe sensor 370 can be used to emulate a perception stack by using the returned information to determine what objects are around the probe sensor 370 and how they are moving using reduced computational resources, which are available to achieve a desirable performance, for example, a real-time frame rate. The perception stack informs how the machine views the world around it, in this case, how a robot views its surroundings. The robot can be a virtual robot and/or a real-world robot. For a robot in the warehouse floor application scenario, the probe sensor 370 can be used to detect and identify obstacles in the robot's path to help guide its rerouting so as to enable the most efficient fulfillment. Accordingly, the technical solutions described herein are rooted in computing technology and further provide an improvement to computing technology. Further, the technical solutions described herein provide a practical application, such as capturing information that can be used to reroute/re-simulate one or more robots.

Embodiments of the technical solutions described herein provide a performance improvement because when shooting rays 610 in the FOV, the probe sensor 370 does not shoot rays 610 in every single discreet position of the FOV because such extreme workload yields low performance as noted. Instead, by using stochastic raytracing, the probe sensor 370 randomly shoots X, Y, Z numbers of rays per frame in a manner that enables a precise view that is both realistic and highly efficient.

Each of the rays 610 that is stochastically emitted provides the information parameters like ray origin, direction, and collision, etc., which can be used to calculate distance from the detected object and the direction of the object relative to the probe sensor 370. With such a probe sensor onboard the robot, available resources are used efficiently by leveraging a windowed view that still provides the data quality that is sufficient to obtain the information desired, such as the one or more objects surrounding the probe sensor and movement of such objects. The “windowed” view can also be referred as a “texel” or a “sub-windowed” view because the stochastic nature of emitting the rays 610 to be traced provides a sampling of the surrounding information. Any information loss caused by such sampling (or sub-sampling) is substantially recovered when the samples (or sub-samples) are integrated over time (due to temporal coherence).

In some scenarios, obtaining a higher quality data in the POV may be irreplaceable. For example, a more resource-intensive, omnidirectional lidar approach detects every position within the FOV and can therefore provide a highly detailed point cloud depicting the surrounding environment. Such a detailed and computer intensive approach may be appropriate for certain applications, such as when robots are navigating environments that human operators cannot effectively or safely navigate, or where collisions between robots and humans are to be avoided, etc. However, in other applications, such taxing on computing and power budgets can be avoided by using the stochastic raytracing.

For example, in controlled environments like the aforementioned warehouse scenario, the robot can readily know if it is encountering a wall, an object, another robot, etc. through the use of the segmentationID, objectID, or any other identifier that indicates an identity of an entity of which the point of intersection is a part of. For any given scenario, stencil IDs represent known objects/obstacles in the target environment (300) and give the probe sensor engine 220 the ability to quickly match detected object parameters to an onboard repository of corresponding stencil IDs that define what the object is, and how to proceed when the robot encounters such another object.

FIG. 7 depicts a flowchart of a method for using a probe sensor to capture perceived data and generate perception stack output related to object identification according to one or more embodiments. The robot simulation server 130 can implement the method 700. In some embodiments, the one or more client devices can facilitate execution of one or more operations of the method. In some embodiments, the method is executed by executing one or more computer-executable instructions stored on a memory device, which is non-transitory.

The method 700 that is depicted shows operations that consider that a virtual environment 300 has already been instantiated within a robot simulation session by a robot simulation server 130. However, instantiating the virtual environment 300, with the several objects, items, robots, etc. based on one or more environment parameters can be part of the method 700 in some embodiments.

At block 705, the probe sensor engine 220 instantiates a probe sensor 370. The probe sensor 370 can be an additional object that is included in the virtual environment 300. Alternatively, the probe sensor 370 can be one of the virtual sensors that are mounted on the one or more objects, e.g., robots, which are in the virtual environment 300. In some embodiments, instantiating the probe sensor can include rendering the probe sensor 370 in the virtual environment 300.

Instantiating the probe sensor 370 can be further include setting, or adjusting one or more parameters of the probe sensor 370. For example, the parameters can include type, such as a camera, a LIDAR, a radar, a microphone, or any other type of sensor in which data is captured by emitting one or more rays and detecting information based on received reflections of one or more rays.

Further, the parameters can specify a frequency at which the probe sensor 370 captures information from its surroundings, e.g., every second, every 2 seconds, every millisecond, etc. The frequency can also be specified in some other units, such as every X number of frames as refreshed by the robot simulation server 130.

The surroundings from which the probe sensor 370 captures information can also be specified by the parameters. For example, the surrounding can be specified as a circle with a particular radius. Alternatively, or in addition, the surrounding can be specified (or restrained) based on the reach of the rays 610 emitted. The reach of the rays 610 can be specified in terms of a number of pixels, or real-world distance metrics, which are converted into pixels.

Further, the probe sensor 370 can be associated with a particular robot in the virtual environment 300. For example, the probe sensor 370 can be mounted on the robot (see FIG. 5A-5C for examples). In one or more embodiments, the probe sensor 370 is separate from other sensors that are already part of the robot. Alternatively, in some embodiments, one of the virtual sensors of the robot is used to work as the probe sensor 370.

Further, the probe sensor 370 can be set to operate in a stochastic manner (or not). For example, the number of emitted rays 610, the respective directions of the rays 610, and other attributes associated with the probe sensor 370 can be made stochastic. Other attributes of the probe sensor 370 can be specified to be selected stochastically in other embodiments.

The settings/configurations of the probe sensor 370 can be provided through a file using a predetermined format, e.g., a USD (universal scene description) file. Alternatively, or in addition, the configurations can be provided through a user interface. The configuration can also include each probe sensor's position and orientation in the virtual environment 300.

The probe sensor engine 220 instantiates the probe sensor 370 based on the input settings. The probe sensor engine 220 also maintains a relation between multiple probe sensors 370 that are instantiated in the virtual environment 300. By positioning a set of the probe sensors 370 across the virtual environment 300 at optimal locations, a majority of the virtual environment 300, if not all, can be scanned and captured by the rays 610 from the several probe sensors 370.

At block 708, related (or grouped) probe sensors 370 are identified. In some embodiments, the probe sensor engine 220 keeps a reference to probe sensors 370 through relations specified in their settings, for example, in the USD files. In one or more embodiments, two or more probe sensors 370 in the virtual environment are grouped together. Such a grouping can be specified as part of the settings of the probe sensors 370. For example, a first probe sensor 370 has a parameter that identifies a second probe sensor 370 (and/or any other) as being related. Similarly, the second probe sensor 370 has a parameter that indicates at least the first probe sensor 370 (along with any other) being related. In some embodiments, the virtual environment 300 can include one or more such groups of probe sensors 370. Through the relations, the probe sensor engine 220 obtains metadata such as origin position, direction/orientation of each specific probe sensor 370 in a group.

At block 710, it is checked if the probe sensor is set to operate stochastically. If the probe sensor 370 is set to operate in a stochastic manner, at block 712, at a first timepoint t1, the respective directions in which the n1 rays 610 are emitted by the probe sensor 370 are determined stochastically. Here, n1 can be a predetermined count set as a parameter of the probe sensor 370. Alternatively, in some embodiments, the value of n1 is determined dynamically in a stochastic manner at the first timepoint t1. Here, “stochastically” indicates that the attributes of the rays 610 are determined using random probability distribution or pattern that may be analyzed statistically but may not be predicted precisely. Further, at a second timepoint t2 (t2>t1), the same number (n1) or a different number (n2) of rays 610 are emitted by the probe sensor 370. The directions in which the rays 610 are emitted at t2 are different from those of the rays 610 at t1 because of the stochastically determined directions. Accordingly, the perceived data that is captured in a first frame at t1 can be from different parts of the surroundings of the probe sensor 370 compared to that in a second frame captured at t2. Here, the duration between t1 and t2 is based on the specified frequency of the probe sensor 370. In some cases, if the count n1 of rays 610 emitted is stochastic, a maximum and/or a minimum number of rays 610 emitted by the probe sensor 370 at each timepoint are parameters that can be configured.

In some embodiments, the probe sensor engine 220 uses a single stochastic pattern to emit rays 610 from each probe sensor 370 in a group, i.e., which are specified as being related. In other words, the entire group of probe sensors 370 emits rays 610 in a stochastic manner. Therefore, the state of the combined region of the virtual environment 300 that is within the range of the group of probe sensors 370 is scanned and captured using a stochastic pattern, and thus, by fewer rays 610 that being independently scanned by each probe sensor 370 individually. This can further reduce the number of rays 610 required to scan the combined area, particularly because the overlapping portion of the combined region is considered when generating the rays 610 as part of the entire group of probe sensors 370.

In the case that the probe sensor 370 is configured to not use stochastic modeling, at block 714, the probe sensor 370 emits a predetermined number of rays 610 in a predetermined set of directions. The count and the directions of the rays 610 stays constant at each timepoint and across the several frames of captured perceived data.

At block 716, raytracing is performed for each ray 610 emitted by the probe sensor 370 or collectively by the group of probe sensors 370. The raytracing is performed using one or more of techniques that are either known or will be developed in the future. The raytracing facilitates determining an intersection of each ray 610 with an object in the virtual environment 300. In some embodiments, each probe sensor 370 performs raytracing for each ray 610 that it emits. In other embodiments, the raytracing is managed by the probe sensor engine 220 for each probe sensor 370 that is instantiated. In some embodiments, the collective management of the raytracing by the probe sensor engine 220 facilitates improved performance (e.g., faster speed, fewer computational resources required, etc.) compared to independent raytracing by each probe sensor 370. The raytracing can use the environment engine 210 to determine the object and a component of the object rendered at the pixel corresponding to the point of intersection 601.

At 720, based on the raytracing performed, the perceived data by each ray 610 emitted is determined and stored. In some embodiments, the captured data from a ray 610 is stored in association with the probe sensor 370 from which that ray 610 originated. Accordingly, in some embodiments, the probe sensor engine 220 can be requested to output all perceived data relative to a specific probe sensor 370 from the virtual environment 300. Alternatively, or in addition, the probe sensor engine 220 collects data from all the probe sensors 370 in a group and stores the collective data from the group in an array representing the region spanned by the group of probe sensors 370. The points of intersection from all the probe sensors 370 are transformed into a common coordinate system before storing in the array. By default, the points of intersection that are captured are relative to the probe sensor's 370 position in a coordinate system of the probe sensor 370 (or the robot on which the probe sensor is mounted).

The raytracing facilitates determining the point of intersection 602. Further, as noted herein, each ray 610 returns, based on the point of intersection 602, at least the parameters of RayOrigin, RayCollision, RayDirection, HitObject, HitComponent, HitNormal, HitSegmentationID. SegmentationID can be used to store and retrieve whatever information needed about the object from the robot simulation server 130. For example, SegmentationID can be used to segment scene objects into classes of interest such as floor, wall, other robots, humans, etc. Access to the object and specific component that the ray 610 encounters can be used to ascertain additional information to be used for perception processing such as object's bounding box or the component's material characteristics. Other attributes of the object can also be determined based on what is stored by the robot simulation server 130.

The use of stochastic rays in this manner improves the performance of capturing the perceived data from the surroundings because the number of rays 610 can be limited instead of tracing each point in the field of view. The n1 rays that are emitted in a stochastic manner within the area of the pyramid can be set as a parameter of the probe sensor 370. Further, in the case where multiple probe sensors 370 are instantiated, each single sensor emits the n1 rays 610. Accordingly, the stochastically sampled rays 610 that are emitted enable capturing information about that virtual environment 300 without having to scan every point, in turn facilitating effective data capture performance with reduced utilization of computer resources. Accordingly, technical solutions herein improve the performance of the robot simulation server. Because the sampling of the rays emitted is stochastic over time, and the samples are integrated a more accurate understanding of the surroundings of the probe sensor 370 (and in turn of the robot on which the probe sensor 370 IS mounted) is obtained. Because of the nature of sampling, it can be understood that objects in the virtual environment 300 that have a larger or bigger size (e.g., wall, truck, etc.) are detected quicker compared to objects that are smaller (e.g., soccer ball, box, etc.). Such variance in time to perceive the surroundings is representative of how a real-world perception stack works, and hence, the stochastic modeling according to the one or more embodiments herein does not adversely affect the recognition time, rather follows an expected trend.

The probe sensor 370 emits the rays 610 at the specified frequency. For example, once started, the probe sensor 370 can start rotating with the speed/rate specified in the configuration so as to emulate a rotating head of a perception sensor such as LiDAR.

At block 725, perception stack output of the virtual environment 300 is generated based on the data that is captured by the probe sensors 370 corresponding to its position and direction. The perception stack output represents state of objects in the virtual environment 300 that are visible to the probe sensor 370. In some embodiments, the perception stack output represents the state of objects within a predetermined vicinity of the probe sensor(s) 370.

The perception stack output is used for several actions that are to be performed based on the understanding of the state of the objects. For example, the perception stack output is used for performing actions by the autonomous clients controlled by the machine-controlled client devices 125. The perception stack output can also be used to display information to the operators that manage the user-controlled client devices 115. Further yet, based on the perception stack the robot engine 215 can cause the one or more robots in the virtual environment to perform one or more actions. Several other applications are possible using the perception stack.

The probe sensor engine 220 continues to use the perceived data and the resulting perception stack output thus generated until a subsequent collection of updated perceived data is requested. The updated perceived data can be calculated as per the frequency associated with the probe sensors 370. Alternatively, or in addition, the perceived data may be updated based on a user instruction.

Accordingly, perceived data can be captured using technical solutions herein that facilitate emitting lesser number of rays in a stochastic manner and capture the state of the virtual environment 300 more efficiently than present solutions where an entire scan of the virtual environment 300 is performed. The complete scan requires higher computational resources, time, power, costs, and other resources. Accordingly, embodiments described herein provide improvements to computing technology, particularly a robot simulation server. Further, embodiments described herein provide practical applications to capture perceived data by a robot in a simulated virtual environment and to generate perception stack based on the captured perceived data. Several other applications will be evident to someone skilled in the art.

Further, consider a fleet coordination, for example in an automated warehouse, where a fleet including several robots and other entities (e.g., humans, conveyer belts, etc.) are to be simulated. Such a simulation is done by a robot simulation server that relies on discrete event simulators. However, these types of simulations are not based in physical constraints and are unable to respond to dynamic changes in the simulation's operating environment (e.g.: a human walking through a restricted area). Such cases, which can be “out of the normal” scenarios cannot be modeled into the simulation in a dynamic manner by the nature of such events. Physical simulations, on the other hand, are physically grounded and can read and respond dynamically to data streams of their virtual environments via simulated perception sensors. However, due to computational complexity of perception sensors they cannot be used to simulate such “out of the normal” cases, such as in the above scenario with a fleet of robots.

This creates a disconnect between discrete event and physical simulation techniques. Embodiments of the technical solutions described herein, address such technical challenges with the simulation environment. Because the probe sensors are optimized by the embodiments herein, it is possible to physically simulate not just individual robots but entire fleets with hundreds of robots and thousands of sensors. This makes it possible to close the gap between discrete event simulation and the fleet level and dynamic, physically accurate simulation at the fidelity of individual robot agents.

It should be noted that while so far, the probe sensor 370 has been described for use in a simulated virtual environment 300, the same approach of stochastic sampling of input data streams can also be implemented in hardware sensors and the computationally expensive software stack that manages the physical robot's perception system.

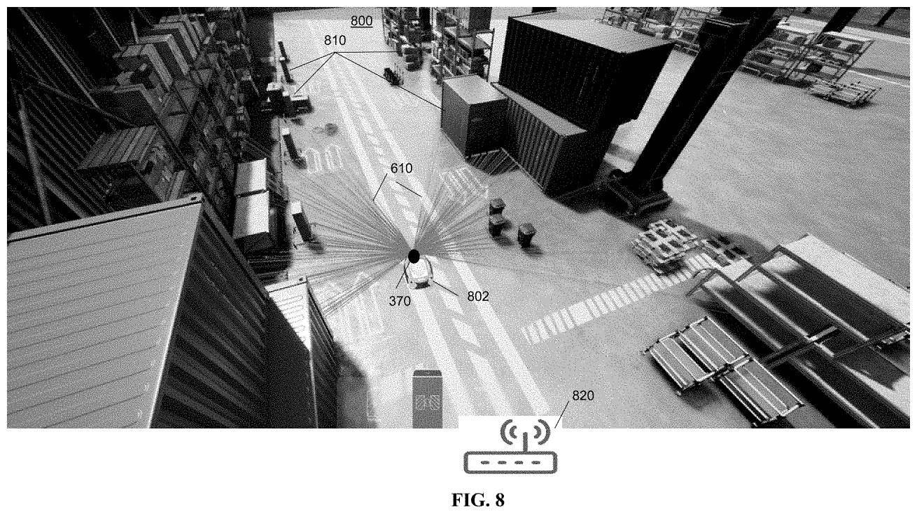

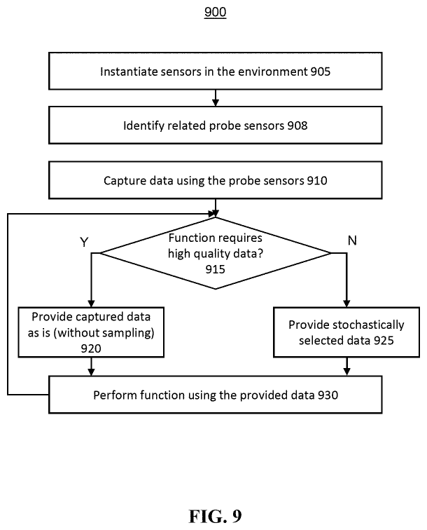

FIG. 8 depicts using a hardware sensor to capture surrounding environment in a stochastic manner according to one or more embodiments. An environment 800 is shown with a robot 802 and with several objects 810. The robot 802 is equipped with a probe sensor 370 that emits several rays 610.

The environment 800, the robot 802, and the probe sensor 370 are simulated similar to the scenario in FIG. 3. Alternatively, the environment 800 can be a real-world environment with the robot 802 being a physical robot and the probe sensor 370 being a hardware sensor. The further description (FIGS. 8 and 9), unless stated otherwise, applies to the case with the real-world scenario, the simulated environment being already described herein. In some embodiments, a computing system 820 is communicatively coupled with the probe sensor 370. The computing system 820 receives the data captured by the probe sensor 370. While the computing system 820 is shown separate, in some embodiments, the computing system 820 can be attached to the robot 802. Further, while the computing system 820 is shown to be in communication with the probe sensor 370 in a wireless manner, in some embodiments, the communication can be performed in a wired manner. The computing system 820 can perform one or more functions on the data that is captured by the probe sensor 370. For example, the computing system 820 can create a digital twin of the environment 800 using the data being captured by the sensor 370. Alternatively, or in addition, the computing system 820 can perform object recognition, auditory analysis, or other types of analytics on the captured data. Such analytics and functions (first set of functions) required high quality and precision scans from the sensor 370. Hence, the sensor 370 can be configured to capture frames of data (e.g., images, point clouds, audio, etc.) at least at a predetermined level of quality (e.g., resolution (4K, 8K, etc.), frequency (120 Hz, 240 Hz, etc.)). Accordingly, the sensor 370 emits a consistent number of rays (610) to capture such predetermined quality frames of data.

Although a single robot 802 and a single sensor 370 are depicted, in one or more embodiments, the computing system 820 is in communication with multiple (2+) robots 802 and sensors 370. The computing system 820 uses frames captured by each of the sensors to generate a cumulative data of the environment 800.

In the real-world scenario, the method 700 can be executed with the probe sensor 370 being a hardware sensor, such as a camera, a LiDAR, a radar, a microphone, etc. The probe scenario 370 can be configured using the one or more settings as described herein. Particularly, the probe sensor 370 is configured to be operated in a stochastic manner. As described herein, fewer rays 610 are emitted by the probe sensor 370 at each timepoint when data is being captured, but the rays 610 are emitted in a stochastic manner. Here, the captured data (image, point cloud, audio) based on the emitted rays 610, is segmented and analyzed to recognize the one or more objects 810 in the surroundings of the probe sensor 370. For example, the robot 802 includes a client (110, 115, 125), and accordingly includes one or more modules to analyze the captured data. Such analysis can include object segmentation, object recognition, and several other such aspects described herein. In some embodiments, the robot 802 may transmit the captured data to another computing device, for example, a server, or a client device that is external to the robot 802 for performing such analysis. Several possibilities exist without limiting the technical solutions provided by the disclosure herein.

It is understood that while the scenario in FIG. 8 depicts a warehouse with the objects 810 being those typically observed in a warehouse (e.g., packages, shelves, containers, pallets, etc.), in other embodiments, the scenario can be any other environment (e.g., office building, factory, playground, etc.). For each ray 610, based on the segmentation and analysis of the captured data, the perceived data is determined and stored. The perceived data includes similar attributes including HitObject, HitComponent, HitNormal, HitSegmentationID.

The captured data in each frame will have lesser precision compared to a complete scan (dense scan without stochastic selection of rays). However, because the data is captured in a stochastic manner, over a series of frames captured by the probe sensor 370, the lesser precision data is suitable for recognition of at least particular objects 810, such as obstacles to be avoided by the robot 802. For example, the stochastically captured data can be used to detect large packages, walls, shelves, and other such objects which have at least a predetermined size (or dimensions). Based on such detection, the robot 802 can be continued to be operated autonomously (or semi-autonomously). Accordingly, the stochastically captured data by a hardware sensor in a physical real-world can be used to determine perceived data and generate a perception stack output that is used for further control of the robot or any other application.

In some embodiments, capturing the data at full precision may be important. For example, when digital twins are to be created. The higher the precision of the scans the higher the quality of the virtual environment (e.g., 300), and in turn, more realistic is the simulation. However, while the full precision scans may be captured for such reasons, the same high quality (above a predetermined threshold) may not be required for navigating the robot 802 through the environment.

Accordingly, there is a technical challenge where varying quality of scans may be desired for different functions, such as creation of a digital twin (higher quality) and navigation (lower quality). In such scenarios, the data captured by the probe sensor 370 using stochastically transmitted rays 610 may not provide the desired high quality/precision scan. Other functionalities may exist that require different quality scans from the robot 802. Embodiments herein address such technical challenges by capturing full quality/precision scan, and stochastically sampling (or sub-sampling) the captured data. The stochastically selected data is used for the functions, such as the navigation. Whereas the (unsampled) captured data is used for the other functionalities (such as creation of the digital twin).

FIG. 9 depicts a flowchart of a method for capturing data of an environment in an efficient manner using probe sensors according to one or more embodiments. The method 900 can be executed by a system that includes the computing system 820 and the one or more sensors 370 that are mounted on robots 802. The robots 802 move (autonomously, semi-autonomously, or manually) through the environment 800 that is being scanned and/or captured.

At block 905, each of the probe sensors 370 are configured (i.e., settings adjusted). The configuration can include setting, or adjusting one or more parameters of the probe sensor 370. For example, the parameters can include quality (e.g., resolution, frequency, etc.) related parameters, which can dictate attributes such as number of rays emitted by the sensor 370. The emitted rays are used for detecting information based on received reflections of the one or more rays. Further, the parameters can specify a frequency at which the probe sensor 370 captures information from its surroundings, e.g., every second, every 2 seconds, every millisecond, etc. The frequency can also be specified in some other units, such as every X number of frames as refreshed by the robot simulation server 130.

Further, the probe sensor 370 can be set to operate in a stochastic manner (or not). For example, the number of emitted rays 610, the respective directions of the rays 610, and other attributes associated with the probe sensor 370 can be made stochastic. Other attributes of the probe sensor 370 can be specified to be selected stochastically in other embodiments.

The settings of the probe sensor 370 can be provided via an interface of the probe sensor 370, the robot 802, and/or the computing system 820. The settings can also be provided via a configuration file in some embodiments. In some embodiments, the computing system 820 maintains a relation between multiple probe sensors 370 that are instantiated in the environment 800. By positioning a set of the probe sensors 370 across the environment 800 at optimal locations, a majority of the environment 800, if not all, can be scanned and captured by the rays 610 from the several probe sensors 370.

At block 908, related (or grouped) probe sensors 370 are identified. In some embodiments, the probe sensor engine 220 keeps a reference to probe sensors 370 through relations specified in their settings, for example, in the USD files. In one or more embodiments, two or more probe sensors 370 in the virtual environment are grouped together. Such a grouping can be specified as part of the settings of the probe sensors 370. For example, a first probe sensor 370 has a parameter that identifies a second probe sensor 370 (and/or any other) as being related. Similarly, the second probe sensor 370 has a parameter that indicates at least the first probe sensor 370 (along with any other) being related. In some embodiments, the environment 800 can include one or more such groups of probe sensors 370. Through the relations, the computing system 820 obtains metadata such as origin position, direction/orientation of each specific probe sensor 370 in a group.

At block 910, frames of data are captured using the one or more probe sensors 370. The capture can be performed as described herein, using raytracing. (See FIG. 7, for example). In some embodiments, the data capture can itself include using stochastic ray emissions. Alternatively, the data is captured at a high resolution (e.g., 4K, 8K, etc.) and high frequency (e.g., 120 Hz, 240 Hz, etc.). The captured data can be larger than what can be analyzed within a certain time, or transmitted within a certain time, etc. Alternatively, or in addition, the amount of data captured can provide other technical challenges related to computing and/or communication resources.

Accordingly, at least for some of the functionalities, at block 915, it is checked if the large amount of data is required to be analyzed. If the function is one that requires high quality and precision data, at block 920, the captured data is provided as captured, i.e., at the captured resolution and frequency, and without any sampling/selection. For example, if the function is to generate a digital twin of the environment, the captured data is used as is. Here, “use” can include transmitting the data, analyzing the data, replicating the data, generating modified data from the captured data, or any other such operation or a combination thereof.

Alternatively, if the high quality and high resolution of the captured data is not required for the function to be performed (e.g., navigating the robot 802, determining incremental change from last frame for rendering, etc.), at block 925, a subset of the captured data is stochastically selected. The stochastically selected data is then provided to be used for the function. The stochastic selection is performed by stochastically selecting a set of rays from the mitted rays 610, and the selecting the data corresponding to the selected rays for the function.

The data that is provided is used to perform the function, at block 930. For example, determining a perception stack output, generating a digital twin, recognizing objects, generating a navigation step, etc., or any other function can be performed with the requisite amount of data being provided. For functions where the entire data is deemed to be required (e.g., digital twin), the entire data from the frame is used.

Embodiments described herein provide improvements to real world sensors and systems that use such sensors in turn. For example, an imager (e.g., camera) or LIDAR only analyze stochastically selected sub-windows (texels) within the entire image that is captured. In sensors like LIDAR that capture point clouds, only sub-volumes of the captured data are analyzed. The analysis typically done by compute-expensive models (e.g., that use artificial intelligence, machine learning, image processing, etc.). Embodiments herein facilitate addressing such technical challenge with such highly compute-expensive problems by transforming them to a stochastic domain, and further transforming the problem into a domain where raytracing can be performed to look up identities of the hit point (e.g., using segmentationID), instead of performing an object recognition algorithm. Such lookups are computationally less expensive than performing an object recognition algorithm.

Accordingly, embodiments herein facilitate capturing data from a sensor in a stochastic manner and/or using data captured by the sensor in a stochastic manner. When the data is captured in a stochastic manner, the sensor emits rays 610 in a stochastic manner, and the entire frame that is captured as a result can be used for the function, such as computing a navigation step of the robot, generating a perception stack output, etc. In this case, for functions that require higher quality data, another separate frame has to be captured with the emitted rays 610 not being stochastic. In the case where the data is captured at the higher quality, a single frame of data can be captured and used for the different types of functions with/without stochastic sampling depending on the quality of data deemed to be required for that function.

According to one or more embodiments, technical solutions described herein facilitate instantiating a probe sensor for a virtual environment that comprises a plurality of objects instantiated using one or more environment parameters, the objects comprising one or more robots. The probe sensor is configured to emit a plurality of rays, each ray transmitted in a stochastically selected direction. Data perceived by each ray is captured by raytracing each ray to determine an object in the virtual environment on which the ray is incident. The object can be determined from the simulation server that generates the virtual environment in some embodiments by determining the pixel at which the ray is incident, and identifying the object and/or the object's component that is rendered at that pixel. A perception stack output of the virtual environment is generated for the probe sensor based on the data from the raytracing, the perception stack output representing state of the plurality of objects in a predetermined vicinity of the probe sensor.

In some embodiments, the probe sensor emits a first plurality of rays at a first timepoint t1, and a second plurality of rays at a second timepoint t2. A number of rays at the first timepoint is different from the number of rays emitted at the second timepoint, the number of rays emitted by the probe sensor at any timepoint is stochastically determined.

In some embodiments, the data perceived by a ray from the probe sensor comprises an origin of the ray, a direction of the ray, an identification the object, and an identification of a component of the object on which the ray is incident.

In some embodiments, the state of the plurality of objects indicates a position and movement of the plurality of objects in relation to the probe sensor.

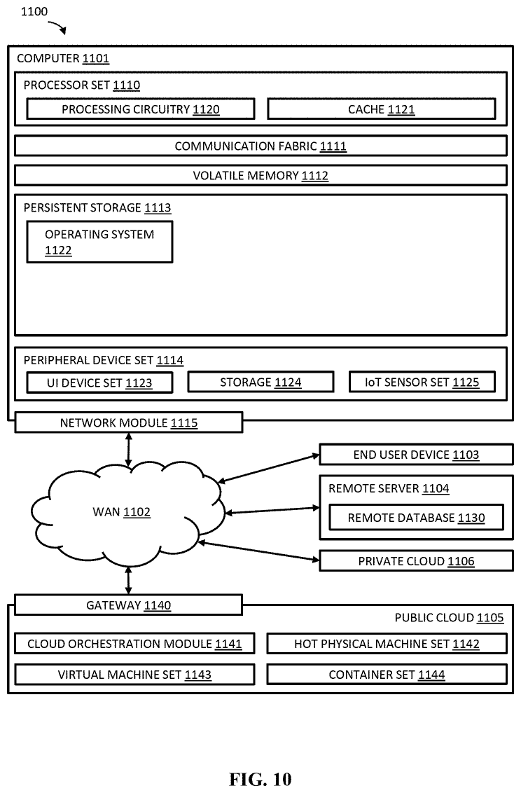

FIG. 10 depicts a computing environment in accordance with one or more embodiments. Computing environment 1100 contains an example of an environment for the execution of at least some of the computer code involved in performing the inventive methods, such as simulating robotic behavior and using a probe sensor to capture perceived data. The computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122, as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smartwatch or other wearable computer, mainframe computer, quantum computer or any other form of computer or mobile device now known or to be developed in the future that is capable of running a program, accessing a network, or querying a database, such as remote database 1130. As is well understood in the art of computer technology, and depending upon the technology, performance of a computer-implemented method may be distributed among multiple computers and/or between multiple locations. On the other hand, in this presentation of computing environment 1100, detailed discussion is focused on a single computer, specifically computer 1101, to keep the presentation as simple as possible. Computer 1101 may be located in a cloud, even though it is not shown in a cloud. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods may be stored in block 800 in persistent storage 1113.

COMMUNICATION FABRIC 1111 is the signal conduction paths that allow the various components of computer 1101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid state storage devices. Operating system 1122 may take several forms, such as various known proprietary operating systems or open source Portable Operating System Interface type operating systems that employ a kernel. The code included in block 800 typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing very large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101), and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

The present invention can be a system, a method, and/or a computer program product at any possible technical detail level of integration. The computer program product can include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer-readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions can also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for emulating a probe sensor in a virtual environment, the computer-implemented method comprising:
initializing, by a cloud server, a robot simulation session, the initializing comprising:
instantiating the virtual environment within the robot simulation session, a plurality of objects of the virtual environment instantiated using one or more environment parameters; and
instantiating a set of robots within the virtual environment, each robot comprising a virtual sensor; and
for each robot from the set of robots, providing control of the robot to a client, wherein data representative of the virtual environment available to the client comprises data perceived by the virtual sensor corresponding to the robot, wherein capturing the data perceived by the virtual sensor comprises:
emitting a plurality of rays by the virtual sensor, each ray transmitted in a stochastically selected direction; and
capturing the data perceived by each ray by raytracing each ray to determine an object in the virtual environment on which the ray is incident.

2. The computer-implemented method of claim 1, wherein a number of rays emitted as part of the plurality of rays from the virtual sensor is stochastically determined.

3. The computer-implemented method of claim 2, wherein a first virtual sensor of a first robot from the set of robots emits a first number of rays and a second virtual sensor of a second robot from the set of robots emits a second number of rays, the first number and the second number being distinct.

4. The computer-implemented method of claim 1, wherein the virtual sensor selects a first set of directions for a first plurality of rays, and a second set of directions for a second plurality of rays, wherein the first plurality of rays is transmitted to capture a first frame of information and the second plurality of rays is transmitted to capture a second frame of information.

5. The computer-implemented method of claim 4, wherein the first frame of information is captured at time t1, and the second frame of information is captured at time t2, t2>t1.

6. The computer-implemented method of claim 1, wherein the virtual sensor is one from a group of virtual sensors comprising a camera, a LIDAR, a radar, and a microphone.

7. The computer-implemented method of claim 1, wherein the data perceived by the virtual sensor comprises an origin of the ray, a direction of the ray, an identification the object, and an identification of a component of the object on which the ray is incident.

8. The computer-implemented method of claim 1, further comprising, generating a perception stack output of the virtual environment based on the data perceived by the set of robots.

9. The computer-implemented method of claim 1, wherein each robot from the set of robots captures the data perceived at a discrete periodic interval.

10. A system comprising:
a cloud server for simulating robot behavior, the cloud server comprising at least one processor configured to execute instructions stored on a non-transitory computer-readable storage medium, the cloud server is configured to:
instantiate a virtual environment within the robot simulation session, the virtual environment comprising a plurality of objects instantiated using one or more environment parameters, the objects comprising one or more robots; and
instantiate a probe sensor that is configured to:
emit a plurality of rays, each ray transmitted in a stochastically selected direction, and
capture data perceived by each ray by raytracing each ray to determine an object in the virtual environment on which the ray is incident; and
generate a perception stack output of the virtual environment based on the data that is captured by the probe sensor, the perception stack output representing state of the plurality of objects in a predetermined vicinity of the probe sensor.

11. The system of claim 10, further comprising one or more client devices in communication with the cloud server, the one or more client devices configured to provide control of the one or more robots in the virtual environment based on the perception stack output.

12. The system of claim 11, wherein the one or more client devices comprise a first client device that facilitates operating a first robot manually and a second device that autonomously operates a second robot.

13. The system of claim 10, wherein the probe sensor emits a first plurality of rays at a first timepoint t1, and a second plurality of rays at a second timepoint t2, and wherein a number of rays at the first timepoint is different from the number of rays emitted at the second timepoint.

14. The system of claim 13, wherein the number of rays emitted by the probe sensor at any timepoint is stochastically determined.

15. The system of claim 10, wherein the data perceived by a ray from the probe sensor comprises an origin of the ray, a direction of the ray, an identification the object, and an identification of a component of the object on which the ray is incident.

16. The system of claim 10, wherein the probe sensor is mounted on a robot from the set of robots.

17. A system to capture data of an environment, the system comprising:
a sensor; and
one or more processing units in communication with the sensor, wherein the one or more processing units are configured to:
stochastically select data from a frame captured by the sensor; and
determine a perception stack output based on the stochastically selected data.

18. The system of claim 17, wherein the one or more processing units are further configured to use entire data from the frame for a second function, wherein the second function can be one of creating a digital twin, recognizing objects.

19. The system of claim 17, wherein the sensor is one of a LIDAR, a camera, a radar, and a microphone.

20. The system of claim 17, wherein the one or more processing units are further configured to direct the sensor to capture the frame using stochastically emitted rays, and use the entire frame to generate the perception stack output.
